(19) United States
(12) Patent Application Publication
(10) Pub. No.: US 2026/0044437 A1
(43) Pub. Date: Feb. 12, 2026

(54) SYSTEM AND METHOD FOR FUZZING

(71) Applicant: C2A-SEC, LTD., Jerusalem (IL)

(72) Inventors: Yitzhack DAVIDOVICH, Jerusalem (IL); Frank SPITZNER, Hohentengen (DE); Yehuda TERNER, Jerusalem (IL)

(21) Appl. No.: 19/100,681

(22) PCT Filed: Aug. 3, 2023
(86) PCT No.: PCT/IL2023/050810

§ 371 Date: Feb. 3, 2025

Related U.S. Application Data
(60) Provisional application No. 63/394,994, filed on Aug. 4, 2022.

(51) Int. Cl. G06F 11/3668

(52) U.S. Cl. CPC G06F 11/3684

(57) ABSTRACT

A method for fuzzing constituted of: continuously generating units of data; inputting each of the generated units of data into a tested device; and adding each of one or more hooks to a respective one of one or more predetermined points of interest in a binary executable file running on the tested device, wherein responsive to the input units of data, each hook outputs information associated with the respective point of interest, the output information comprising data stored in a respective address of a memory associated with the respective point of interest, wherein the generation of the units of data is responsive to the output information associated with the respective points of interest.

### TECHNICAL FIELD

The present disclosure relates substantially to the field of software testing, and in particular to a system and method for fuzzing.

### BACKGROUND

In programming and software development, fuzzing or fuzz testing is an automated software testing technique that involves providing invalid, unexpected, or random data as inputs to a computer program. The program is then monitored for exceptions such as crashes, failing built-in code assertions, or potential memory leaks. Unfortunately, current fuzz testing systems do not provide fast, efficient and high-quality enough testing.

### SUMMARY

Additional features and advantages of the invention will become apparent from the following drawings and description.

In some examples, a system for fuzzing is provided, the system comprising a fuzzer data generator configured to continuously generate units of data. In some examples, the system comprises a first input subsystem configured to input each of the generated units of data into a tested device, an input of the first input subsystem in communication with an output of the fuzzer data generator and an output of the first input subsystem in communication with the tested device.

In some examples, the system comprises a first fuzzing agent configured to add each of one or more hooks to a respective one of one or more predetermined points of interest in a binary executable file running on the tested device, wherein responsive to the input units of data, each hook outputs information associated with the respective point of interest, the output information comprising data stored in a respective address of a memory associated with the respective point of interest.

In some examples, the system comprises a fuzzer evaluation functionality configured to receive the information from each of the one or more hooks.

In some examples, the fuzzer data generator is in communication with the fuzzer evaluation functionality and the generation of the units of data by the fuzzer data generator is responsive to an output of the fuzzer evaluation functionality.

Unless otherwise defined, all technical and scientific terms used herein have the same meaning as commonly understood by one of ordinary skill in the art to which this invention pertains. In case of conflict, the patent specification, including definitions, governs. As used herein, the articles “a” and “an” mean “at least one” or “one or more” unless the context clearly dictates otherwise. As utilized herein, “and/or” means any one or more of the items in the list joined by “and/or”. As an example, “x and/or y” means any element of the three-element set {(x), (y), (x, y)}. In other words, “x and/or y” means “x, y or both of x and y”. As another example, “x, y, and/or z” means any element of the seven-element set {(x), (y), (z), (x, y), (x, z), (y, z), (x, y, z)}.

Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of embodiments of the instant inventive concepts. This is done merely for convenience and to give a general sense of the inventive concepts, and “a” and “an” are intended to include one or at least one and the singular also includes the plural unless it is obvious that it is meant otherwise.

As used herein, the term “about”, when referring to a measurable value such as an amount, a temporal duration, and the like, is meant to encompass variations of +/−10%, more preferably +/−5%, even more preferably +/−1%, and still more preferably +/−0.1% from the specified value, as such variations are appropriate to perform the disclosed devices and/or methods.

The following embodiments and aspects thereof are described and illustrated in conjunction with systems, tools and methods which are meant to be exemplary and illustrative, but not limiting in scope. In various embodiments, one or more of the above-described problems have been reduced or eliminated, while other embodiments are directed to other advantages or improvements.

### BRIEF DESCRIPTION OF DRAWINGS

For a better understanding of the invention and to show how the same may be carried into effect, reference will now be made, purely by way of example, to the accompanying drawings in which like numerals designate corresponding sections or elements throughout.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how several forms of the invention may be embodied in practice. In the accompanying drawings:

FIGS. 1A-1D illustrate various portions of an example of a fuzzing system, in accordance with some examples of the disclosure;

FIGS. 2A-2B illustrates a neural network setup for generating data units for the system of FIGS. 1A-1C;

FIG. 3A-3B illustrates various high-level block diagrams of an example of a fuzzing system incorporating the neural network setup of FIGS. 2A-2B;

FIGS. 3C-3E illustrate various diagrams describing a method of operation of the fuzzing system of FIG. 3A;

FIG. 4A illustrates a high-level block diagram of an example of a fuzzing system, in accordance with some examples of the disclosure;

FIG. 4B illustrates a more detailed example of the fuzzing system of FIG. 4A;

FIGS. 4C-4E illustrates various high-level flow charts of a method of fuzzing utilizing both network-level fuzzing and function-level fuzzing;

FIG. 4F illustrates a high-level block diagram illustrating the placement of hooks 111 throughout a call tree;

FIG. 4G illustrates a high-level block diagram of a fuzzing agent comprises a plurality of event handlers, in accordance with some examples of the disclosure;

FIG. 5A illustrates a high-level block diagram of an example of a fuzzing system, in accordance with some examples of the disclosure;

FIG. 5B illustrates a high-level block diagram of an example of a fuzzing system, in accordance with some examples of the disclosure;

FIGS. 6A-6F illustrate various high-level block diagrams of examples of proxy-based fuzzing systems;

FIG. 7 illustrates a high-level flow chart of a method of signal-based fuzzing, in accordance with some examples of the disclosure; and

FIG. 8 illustrates a high-level flow chart of a method of determining statistical independence of signals, in accordance with some examples of the disclosure.

### DETAILED DESCRIPTION OF CERTAIN EMBODIMENTS

In the following description, various aspects of the disclosure will be described. For the purpose of explanation, specific configurations and details are set forth in order to provide a thorough understanding of the different aspects of the disclosure. However, it will also be apparent to one skilled in the art that the disclosure may be practiced without specific details being presented herein. Furthermore, well-known features may be omitted or simplified in order not to obscure the disclosure. In the figures, like reference numerals refer to like parts throughout. In order to avoid undue clutter from having too many reference numbers and lead lines on a particular drawing, some components will be introduced via one or more drawings and not explicitly identified in every subsequent drawing that contains that component.

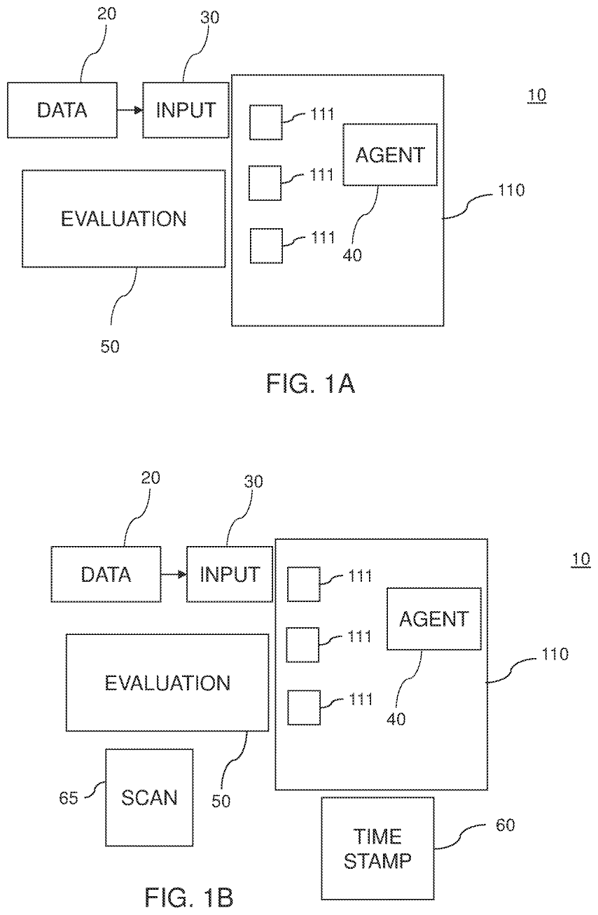

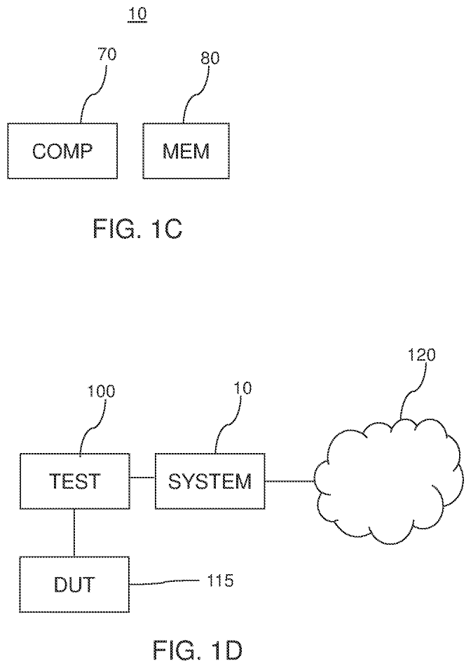

FIG. 1A illustrates a high-level block diagram of a system 10 for fuzzing. In some examples, system 10 for fuzzing comprises: a fuzzer data generator 20; an input subsystem 30; a fuzzing agent 40; and a fuzzer evaluation functionality 50. In some examples, fuzzing agent 40 comprises a time stamp generator 60. Time stamp generator 60 generates time stamps, as known to those skilled in the art. In another example, time stamp generator 60 is external to fuzzing agent 40, as will be described below.

In some examples, as illustrated in FIG. 1C, security vulnerability testing system 10 comprises: at least one processor 70; and a memory 80. In such an example, memory 80 has stored therein a plurality of instructions that when run by at least one processor 70 cause at least one processor 70 to perform the functions of fuzzer data generator 20, input subsystem 30, fuzzing agent 40 and fuzzer evaluation functionality 50. Thus, in such an example, fuzzer data generator 20, input subsystem 30, fuzzing agent 40 and fuzzer evaluation functionality 50 are each comprised of a respective set of instructions stored on memory 80.

The terms “fuzzer data generator”, “fuzzing agent” and “fuzzer evaluation functionality”, as used herein, mean various portions of a fuzzer.

In some examples, as illustrated in FIG. 1D, system 10 for fuzzing is implemented in cooperation with a test tool 100, such as the CANoe software tool commercially available from Vector Informatik GmbH of Stuttgart, Germany. In some examples, test tool 100 comprises various simulations of network access interfaces and simulated electronic control units (ECUs). In another example, fuzzer evaluation functionality 50 is implemented on test tool 100.

Fuzzing agent 40 adds one or more hooks 111 to a binary executable file 110, each hook 111 added to a respective predetermined point of interest in binary executable file 110. The term “hook 111”, as used herein, means one or more lines of code that change the operation of binary executable file 110 at the point where the hook 111 is located. In some examples, each hook 111 branches to fuzzing agent 40, as will be described below. In some examples, binary executable file 110 is of a device-under-test (DUT) 115 being tested at test tool 100. The term “binary executable file”, as used herein, means a file in a machine language designed for a respective processor, i.e. the binary executable file contains executable code that is represented in specific processor instructions, as known to those skilled in the art.

In some examples, time stamp generator 60 is part of DUT 115 or test tool 100. In such an example, fuzzing agent 40 is optionally in communication with time stamp generator 60 and requests time stamps from time stamp generator 60 as required. In another example, each hook 111 requests a time stamp from time stamp generator 60 upon being activated.

In some examples, a hook 111 is added by replacing the opcode at the respective point of interest with a branch instruction to branch to fuzzing agent 40. In another example, a hook 111 is added by overwriting the address of the respective point of interest in a procedure linkage table (PLT) associated with binary executable file 110. In some examples, fuzzing agent 40 adds the one or more hooks 111 to binary executable file 110 without re-compiling binary executable file 110.

In some examples, fuzzing agent 40 is embedded within binary executable file 110. The following describes an example for embedding fuzzing agent 40 with binary executable file 110, however this is not meant to be limiting in any way, and any known methods of embedding can be used without exceeding the scope of the disclosure.

In some examples, where the source code of binary executable file 110 is available, and binary executable file 110 is provided in an executable and linkable (ELF) format, embedding fuzzing agent 40 into binary executable file 110 is accomplished by analyzing the file by a preparation script to find available space which the fuzzing agent 40 can fit into. In the event that there is sufficient space within the existing segments, a portion of the PROGBITS, i.e. a portion of the program content, of fuzzing agent 40 are copied into the binary program image within the available space. While copying the PROGBITS of fuzzing agent 40, preferably the relative distance between different sections within fuzzing agent 40 is maintained. Particularly, sections of the ELF file which contain various types of data and are loaded on runtime need to be mapped to addresses in the CPU memory. The mapping is performed by segments, as known to those skilled in the art at the time of the invention. Each segment contains a sequence of consecutive PROGBITS sections which are loaded together to the address specified by the segment. Thus, the added segments for fuzzing agent 40 will load the added PROGBITS sections to the process address space on runtime.

In the event that there isn't sufficient space within the existing segments, two new segments are added to the ELF file by the preparation script. The first segment is for read-only executable text and the second segment is for read-write access. Sections of fuzzing agent 40 are then added to the added segments. Specifically, the read-write access PROGBITS sections comprise data and the global offset table (GOT). All of the segments of the ELF file are listed in a program header table. After adding the two new segments, the program header table no longer fits in its original offset. Therefore, the program header table is moved by the preparation script to the end of the ELF file. A third segment is then added to the program header table by the preparation script, the third segment arranged to load the program header table from its new location to the process address space on runtime to allow the process to be loaded and executed. Code is position independent, therefore relocation within the address space does not require any modifications as long as the relative distance between different sections is maintained. However, sometimes there are global offsets in the code. These offsets are stored in the GOT and are modified by the preparation script to reflect the relocation of the addresses.

Input subsystem 30 comprises a software and/or firmware input to binary executable file 110 of DUT 115. Particularly, an input of input subsystem 30 is in communication with an output of fuzzer data generator 20 and an output of input subsystem 30 is in communication with DUT 115. In some examples, input subsystem 30 comprises a network interface.

In some examples, as described below, input subsystem 30 can input data units, such as data packets, both through: a network interface, for network-level fuzzing; and through an emulator for function-level fuzzing. The term “network-level fuzzing”, as used herein, means fuzzing an instrumented binary executable file of a device with simulations of ECUs, and/or various ports and devices, as known to those skilled in the art. The term “function-level fuzzing”, as used herein, means using an emulator which contains the state of the memory associated with the process arriving at a particular function, and then directly providing data units to the function.

In some examples, fuzzer evaluation functionality 50 is not embedded in binary executable file 110. In some examples, fuzzer evaluation functionality 50 is in communication with fuzzing agent 40 and with fuzzer data generator 20. Although fuzzer evaluation functionality 50 and fuzzer data generator 20 are described herein separately, this is not meant to be limiting to two separate and distinct elements. In some examples, fuzzer evaluation functionality 50 and fuzzer data generator 20 are part of a group of combined software instructions, and operate as a single program.

In some examples, as illustrated in FIG. 1D, fuzzer evaluation functionality 50 is in communication with a network 120 suitable for cloud-based computing. In some examples, network 120 is part of the internet. In another example, fuzzer evaluation functionality 50 incorporates the cloud-based computing platform.

In operation, in some examples, fuzzer evaluation functionality 50 receives from a user input (not shown) one or more points of interest in binary executable file 110. In another example, fuzzer evaluation functionality 50 scans binary executable file 110 to identify one or more points of interest. It is noted that these are not exclusive options and fuzzer evaluation functionality 50 can identify points of interest responsive to both: user input; and a scan of binary executable file 110. In some examples, fuzzer evaluation functionality 50 scans binary executable file 110 for known application programming interfaces (APIs). For an automotive open system architecture (AUTOSAR), this can include for example a CanIf_RxIndication.

Other points of interest can include, without limitation, any, or a combination of: runtime environment (RTE) interfaces; internal application functions; AUTOSAR callouts; and various library function-like vectors, such as VStdLib_MemCpy; security related functions, such as functions that access a hardware security module (HSM) or libcrypto; predetermined sensitive functions, such as memcpy; parsers; conditional logic; point in the flow that start from input entry, such as read, rxIndication, processPacket, memcpy, etc.

In some examples, fuzzer evaluation functionality 50 further defines event information that could be useful, such as: a hook 111 hit counter, i.e. how many times a specific hook 111 was reached; notification of when the value of a particular register equals an expected value; notification regarding a corrupted memory stack; and notification of a heap overflow. In some examples, the event information types are defined, and/or approved by a user.

The above has been described in an example where fuzzer evaluation functionality 50 defines the points of interest and the events, however this is not meant to be limiting in any way. In another example, as illustrated in FIG. 1B, system 10 further comprises a scan functionality 65. In some examples, scan functionality is implemented by a plurality of predetermined instructions stored on memory 80, which when run by processor 70 cause processor 70 to perform the functions of scan functionality 65.

In some examples, scan functionality 65, and/or or fuzzer evaluation functionality 50, scans binary executable file 110 and generates: a list of points of interest; addresses of opcodes, each opcode preceding a respective point of interest and being an opcode of a condition check (i.e. a comparison of a variable to a predefined value); a list of interesting strings, such as service numbers, port numbers, keys, etc.; and a list of software stack characteristics, such as the stack being a transmission control protocol (TCP) stack, an internet protocol (IP) stack, a crypto library, etc. It is noted that not all of the above information needs to be generated and scan functionality 65 and/or fuzzer evaluation functionality 50 can generate only some of the above information, without exceeding the scope of the disclosure.

In some examples, scan functionality 65, and/or fuzzer evaluation functionality 50, generates fuzzer agent 40, fuzzer agent 40 comprising the above generated information and further comprises: code that allows adding hooks 111 to binary executable file 110 during runtime; code that sends information to a predetermined destination, outside of binary executable file 110 or within; one or more buffers to store information of events; and optionally code that performs statistical and security checks, such as memory inspection, function call monitoring, etc.

In some examples, upon initialization, one or more of the hooks 111 extract information from the memory stack associated with the respective point of interest. For example, information is extracted by using the pointer of the associated function that points to the data that needs to be read in order to enter the function, and extracting from the memory stack the data starting at the address pointed to by the pointer. In such an example, the amount of memory read is determined based on the defined length that the function has to read from the memory. In some examples, information from the memory stack is read using a bind function. In some examples, the information comprises the internet protocol (IP) address and port number associated with the respective point of interest. This information is then used for generating data units such that the data units arrive at the respective point of interest. As will be described below, reading the information from the memory stack can be performed after initialization as well.

Fuzzer data generator 20 generates data. In some examples, fuzzer data generator 20 continuously generates units of data. The term “continuously”, as used herein, means that fuzzer data generator 20 generates units of data at predetermined time intervals over a predetermined period of time. In some examples, fuzzer data generator 20 generates at least 1000 new units of data (e.g data packets) every second, optionally at least 1 million new units of data every second. As known to those skilled in the art of fuzzing, the fuzzer data generator of the fuzzer (e.g. fuzzer data generator 20) provides random inputs into software in order to test the software or program. The input generated by fuzzer data generator 20 can take on a variety of forms, such as a network packet, a file of a certain format, a direct user input, a value, and the like. In some examples, fuzzer evaluation functionality 50 controls fuzzer data generator 20 to update the generated unit of data at each time interval, such that the generated unit of data at one time interval is different that the generated unit of data at the next time interval.

In some examples, fuzzer data generator 20 generates data in accordance with predetermined rules. In some examples, the predetermined rules comprise information regarding ranges of memory addresses, predetermined IP addresses, predetermined port numbers and/or selected ECUs that are defined as the area that is being fuzzed. In such an example, the target addresses of the generated data are set in accordance with the predetermined rules. In some examples, this information is extracted by fuzzer data generator 20 and/or fuzzer evaluation functionality 50 from a configuration file, such as a network communication description (NCD) file, and/or using an ECU extract file. As described below, during run time fuzzer evaluation functionality 50 can identify changes in the addresses, ports and/or ECUs being targeted. In such an example, the predetermined rules can be adjusted accordingly.

In some examples, fuzzer evaluation functionality 50 determines the predetermined rules based on a threat analysis and risk assessment (TARA). Fuzzer evaluation functionality 50 can receive the TARA from an external device/network and/or from a user input terminal, as known to those skilled in the art.

In some examples, the generated units of data are input into DUT 115 by input subsystem 30. As described above, for network-level fuzzing, input subsystem 30 inputs the generated units of data at the entry point of the process. For function-level fuzzing, input subsystem 30 inputs the generated units of data directly into the respective function, as described above. In some examples, fuzzing agent 40 is in communication with input subsystem 30 and time stamp generator 60 of fuzzing agent 40 generates a respective time stamp each time input subsystem 30 inputs a data unit into DUT 115. In such an example, when a hook 111 is reached, time stamp generator 60 generates a respective time stamp. The term “reached”, as used herein, means that the flow of data has activated the respective hook 111.

In some examples, responsive to the input units of data, each hook 111 outputs to fuzzing agent 40 information associated with the respective point of interest. Particularly, the respective point of interest is the point of interest at which the respective hook 111 was added. In some examples, as described below, the information comprises data stored in an address of a memory (such as memory 80) associated with the respective predetermined point (e.g. values stored in a memory address range pointed to by a pointer of the respective function, the value of a pointer of the respective function, a respective IP number and/or a respective port number). In some examples, the information associated with the respective point of interest is indicative of security vulnerabilities of DUT 115. In some examples, the information associated with the respective point of interest comprises an indication of a security vulnerability associated with a heap or stack associated with executable binary file 110. In another example, alternatively or additionally, the information associated with the respective point of interest comprises an indication of a library access. In some examples, the information associated with the respective point of interest comprises an indication of a memory stack overflow or memory heap overflow. This can include an address pointed to which is outside the address ranged of the memory stack or memory heap.

In some examples, alternatively or additionally, the information associated with the respective point of interest comprises an indication that the respective point of interest was reached. In such an example, fuzzer evaluation functionality 50 performs a statistical evaluation of the number of time that each of the predetermined points of interest was initiated. The outcome of the statistical analysis is compared to predetermined parameters and thresholds to determine whether a security vulnerability exists.

In some examples, as described above, the information associated with the respective point of interest can also comprise data copied from the memory stack. In some examples, as described above, the IP address and/or port number associated with the respective point of interest is read. In some examples, fuzzer evaluation functionality 50 compares the copied information from the memory stack to the corresponding information copied from the memory stack upon initialization. If there is a difference in the information, such as a change in the IP address or port number, fuzzer evaluation functionality 50 outputs an indication of the presence of such a difference. In some examples, such an indication is added to a report that indicates the security vulnerabilities and/or software bugs present in DUT 115.

In some examples, fuzzer evaluation functionality 50 evaluates the received information to identify issues in control flow integrity (CFI). For example, fuzzer evaluation functionality 50 compares the value of a pointer of a respective function to a stored address value associated with the respective function. If the value of the pointer is not equal to the stored address value, fuzzer evaluation functionality 50 determines that there is a problem with the CFI and in some examples outputs an indication of the presence of such a problem, optionally including the value of the pointer and information regarding the respective data unit which was input.

In some examples, the information associated with the respective point of interest is stored in a predetermined portion of a global buffer. In some examples, each portion of the global buffer is associated with a respective hook 111. In some examples, each portion of the global buffer has stored therein identifiers for each task that can include the respective hook 111. In some examples, the information in the global buffer is read by using a dedicated debug unified diagnostics service (UDS) data identifier (DID). In another example, an existing UDS DID is used to read the global buffer. In some examples, the data is read from the buffer by the UDS DID using a diagnostic communication manager (DCM) callout or DCM service port.

In another example, fuzzing agent 40 is configured to transmit the information to fuzzer evaluation functionality 50 using a user datagram protocol (UDP), a controller area network (CAN) message. In some examples, fuzzing agent 40 sends one or more data packets with the information to fuzzer evaluation functionality 50. In some examples, fuzzing agent 40 sends multiple copies of the information to fuzzer evaluation functionality 50. In another example, fuzzing agent 40 additionally sends one or more cookies along with the data so that fuzzer evaluation functionality 50 can keep track of whether any data from fuzzing agent 40 did not arrive.

In another example, a debugger constantly polls the global buffer, optionally the read data being output to test tool 100 via an application interface (e.g. a Windows dll file).

In some examples, responsive to the respective output information of a hook 111, fuzzing agent 40 determines which of the input units of data reached the respective hook 111. In some examples, where time stamp generator 60 generates a time stamp when each data unit is input by input subsystem 30, and when each hook 111 is reached, the determination which of the input units of data reached the respective hook 111 is responsive to the generated time stamps. Particularly, fuzzing agent 40 compares the time stamp generated when the respective hook 111 was reached to the time stamps generated upon input of the data units. The differences between the time stamps are compared to a predetermined time lapse threshold, and responsive to one of the differences being within a predetermined range of the time lapse threshold, the associated data unit is determined as being the data unit that reached the respective hook 111. In another example, the determination which of the input units of data reached the respective hook 111 is performed by fuzzer evaluation functionality 50.

In some examples, a dedicated counter is provided for each point of interest. The counter can be implemented in any of the: respective hook 111; fuzzing agent 40; and fuzzer evaluation functionality 50. The counter indicates how many times the point of interest was reached. This information can be used for statistical analysis, as described above, and for updating the data units, as will be described below.

Fuzzer data generator 20 is responsive to an output of fuzzer evaluation functionality 50. In some examples, fuzzer evaluation functionality 50 indicates to fuzzer data generator 20 how the units of data should be updated (e.g. which bits of the data unit to mutate for the fuzzing process). In another example, fuzzer evaluation functionality 50 controls fuzzer data generator 20 to update the units of data. In some examples, selected portions of the units of data are randomly updated. In another example, the selected portions of the units of data are updated in accordance with predetermined rules or models. In another example, the selected portions of the units of data are updated responsive to the detected security vulnerabilities.

In some examples, fuzzer data generator 20 generates the units of data responsive to an outcome of the determination which of the input units of data reached the respective hook 111. Particularly, if a particular data unit reached the respective hook 111, fuzzer evaluation functionality 50 causes fuzzer data generator 20 to generate updated units of data using that particular data unit as a reference. Advantageously, the information received by the hooks 111 allows for more efficient updating of the data units being input into DUT 115.

In some examples, where fuzzer evaluation functionality 50 and fuzzer data generator 20 are embedded in binary executable file 110, fuzzer evaluation functionality 50 controls fuzzer data generator 20 to input data units directly into respective functions of binary executable file 110.

In some examples, the input data units are continuously updated until each of the hooks 111 has been reached. In another example, the input data units are continuously updated until each of the hooks 111 has been reached at least a predetermined number of times. In some examples, evaluation functionality 50 generates multiple instances of attack scenarios, and for each batch of scenarios there is a respective subset of hooks 111 added to binary executable file 110. Advantageously, the performance impact of the hooks 111 is negligible, and maximal coverage is achieved after running all of the scenarios repeatedly.

In some examples, responsive to the information received at fuzzer evaluation functionality 50, fuzzer evaluation functionality 50 outputs to fuzzing agent 40 an indication of a respective point of interest. Responsive to the output indication of the respective point of interest, fuzzing agent 40 adds a respective hook 111 to an additional location in binary executable file 110 associated with the respective point of interest. In some examples, the additional location is located earlier in the flow of the binary executable file that the respective point of interest. The term “earlier in the flow”, as used herein, means that the instructions of the additional location are run before the instructions of the respective point of interest.

In some examples, fuzzer evaluation functionality 50 outputs to fuzzing agent 40 and indication of the respective point of interest responsive to not receiving information associated with the respective point of interest was reached over a predetermined number of time intervals. Particularly, if after a predetermined number of data units have been input, the respective hook 111 hasn't been reached, fuzzing agent 40 adds another hook 111 at an earlier point in the flow. In some examples, the additional hook 111 can be added responsive to analyzing the stack to determine which points in binary executable file 110 are being affected by the input data units.

In some examples, responsive to a respective one of the one or more hooks 111 not being activated within a respective predetermined number of the predetermined time intervals, fuzzer evaluation functionality 50 identifies a comparison opcode located prior to the respective hook 111. In some examples, the comparison opcode is located by searching the assembly code for the first compare instruction preceding the respective hook 111. The comparison opcode has associated therewith one or more comparison values and one or more variable values (stored in a dedicated register). Particularly, the comparison may be between several registers and respective values. The below is described in relation to a single variable value and a single comparison value, however this is not meant to be limiting in any way.

The term “variable value”, as used herein, means the value of a variable, which is not constant. The term “comparison value”, as used herein, mean a predetermined value that is used for comparison to the variable value. If the variable value equals the comparison value, the comparison condition is met.

Fuzzer evaluation functionality 50 repeatedly receives from fuzzing agent 40 the comparison value and the variable value of the compare instruction over multiple instances of the predetermined time intervals. In some examples, the respective hook 111 comprises a wrapper function that reads the variable value and comparison value from the memory and the branch instruction of the respective hook 111 includes the read values.

In some examples, at least a predetermined number of data units are input while fuzzer evaluation functionality 50 is reading the variable value from the register. Additionally, fuzzer evaluation functionality 50 controls fuzzer data generator 20 to repeatedly adjust the generated units of data responsive to the comparison value and variable value. Particularly, the generated units of data are adjusted such that the variable value will equal the comparison value. In some examples, for each time interval, the variable value is stored by fuzzer evaluation functionality 50.

Responsive to the variable value being equal to the comparison value, fuzzer evaluation functionality 50 determines the necessary adjustment of the generated units of data to cause the variable value to be equal to the comparison value. For example, fuzzer evaluation functionality 50 determines which bits of the data units need to be adjusted to which values in order to meet the compare condition to reach the respective hook 111, as will be described below. Fuzzer evaluation functionality 50 then controls or indicated to fuzzer data generator 20 what adjustments need to be made to the data units to meet the compare condition.

In some examples, the repeated adjustment of the generated units of data until the variable value is equal to the comparison value is responsive to a predetermined optimization algorithm. Particularly, the optimization algorithm adjusts the input data units and follows the variable value until becoming equal to the comparison value. In some examples, the predetermined optimization algorithm is a gradient descent algorithm. Particularly, as known to those skilled in the art, a gradient descent algorithm is a first-order iterative optimization algorithm for finding a local minimum of a differentiable function.

Sometimes, a function is only reached in rare circumstances. As an example, the function memcpy could be positioned within an if condition, such as this:
if (X[100]==‘R’) {
   memcpy(a,b,c);
}
   In such an example, memcpy will only rarely be reached. Advantageously, the above method allows fuzzing of the function memcpy within a minimal time period.

In some examples, prior to an application of the predetermined optimization algorithm to determine the necessary adjustment, fuzzer evaluation functionality 50 is configured to repeatedly control, or indicate to, fuzzer data generator 20 to insert a predetermined value within a respective location of a respective data unit, the respective location for each repetition being different. For example, at a first iteration, a ‘$’ can be inserted to all bytes of the data unit. Then, fuzzer evaluation functionality 50 analyzes the memory stack associated with binary executable file 110 to determine which of the respective locations in the input data unit affects the memory stack. In the above example, fuzzer evaluation functionality 50 will analyze the stack to determine which address now contains the ‘$’.

In some examples, the generated units of data are repeatedly adjusted until the variable value is equal to the comparison value. The adjustment is in some examples responsive to an outcome of the determination of the respective location. Particularly, as described above, a particular section of each data unit is identified as affecting an address in the vicinity of the respective hook 111. In some examples, the section in each new data unit is altered until the variable value is equal to the comparison value, as described above. For example, if the identified section is the 10th byte of the payload of the data unit, the 10th byte of each new data unit is adjusted until variable value equals the comparison value.

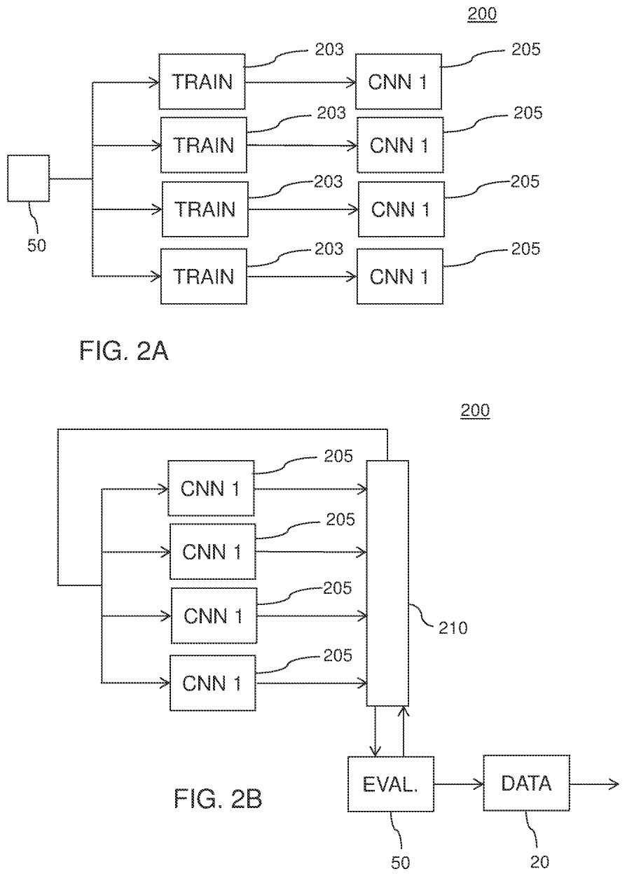

In some examples, as illustrated in FIG. 2A, system 10 for fuzzing further comprises a machine learning (ML) subsystem 200. As described above, in some examples, ML subsystem 200 is implemented by instructions stored on a memory and run by one or more processors. In another example, all, or part, of ML subsystem 200 is implement on a network, such as a cloud-based network. In some examples, ML subsystem 200 comprises: one or more convolutional neural network (CNN) trainers 203; and one or more CNNs 205. The term “CNN trainer”, as used herein, means a system or a software instruction set being run on a processor that trains the respective CNN 205, as known to those skilled in the art. Particularly, a CNN trainer trains a CNN by passing inputs through the CNN and comparing the outputs with acceptable parameters/values. In some examples, training comprises: a forward phase, where the input is passed completely through the network; and a backward phase, where gradients are backpropagated and the weights are updated. “Backpropagation” is short for backward propagation of errors, which is an algorithm for supervised learning of artificial neural networks using gradient descent, as known to those skilled in the art.

As illustration in FIG. 2B, in some examples, subsystem 200 further comprises a data unit functionality 210. Although four CNNs 205 and four CNN trainers 203 are illustrated, this is not meant to be limiting in any way, and any number of CNNs 205 and CNN trainers 203 can be provided (including one) without exceeding the scope of the disclosure. In some examples, data unit functionality 210 is in communication with fuzzer evaluation functionality 50, either through a network interface or other suitable means of communication.

In some examples, fuzzer evaluation functionality 50 is configured to store the respective variable values over the predetermined time intervals. CNN trainers 203 of ML subsystem 200 train CNNs 205 with the stored variable values described above and the respective generated data units associated with the stored variable values. Particularly, for each data unit there is a respective variable value that appears in the register, and the one or more CNNs 205 are trained with the variable values and the respective data units. In some examples, as illustrated, a plurality of CNNs 205 are trained in parallel. In some examples, the training is performed with a binary cross-entropy loss function.

In some examples, if the loss function of at least one of the CNNs 205 converges to a sufficient predetermined low value, the respective CNN 205 will contain a model that receives data units and outputs a value indicating what the variable value would be if the respective data unit was input into DUT 115.

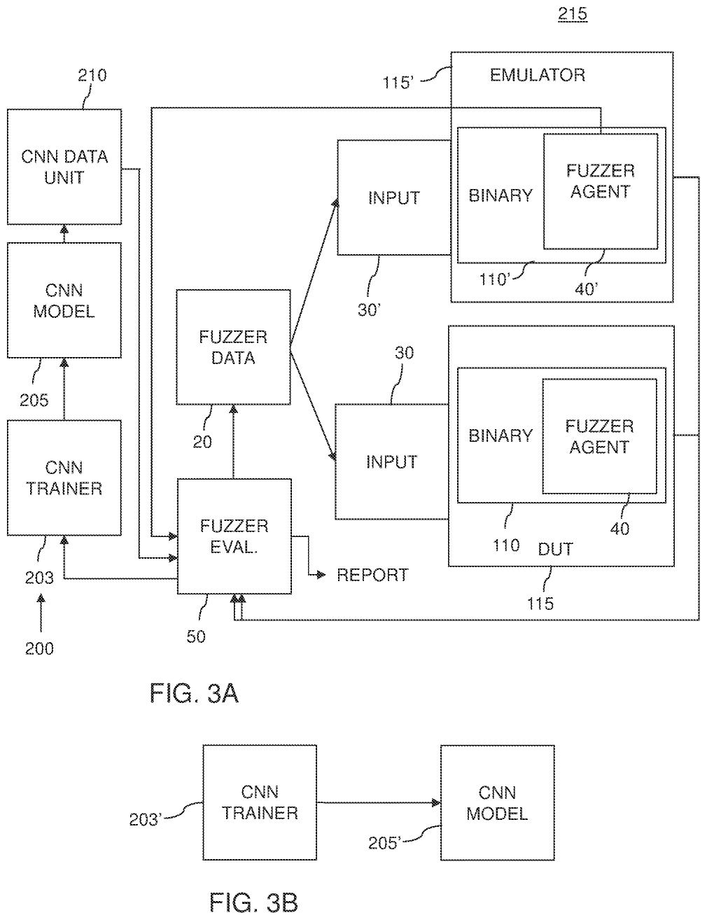

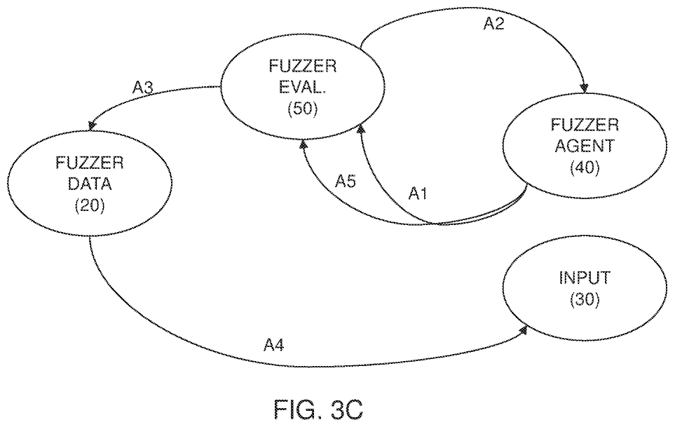

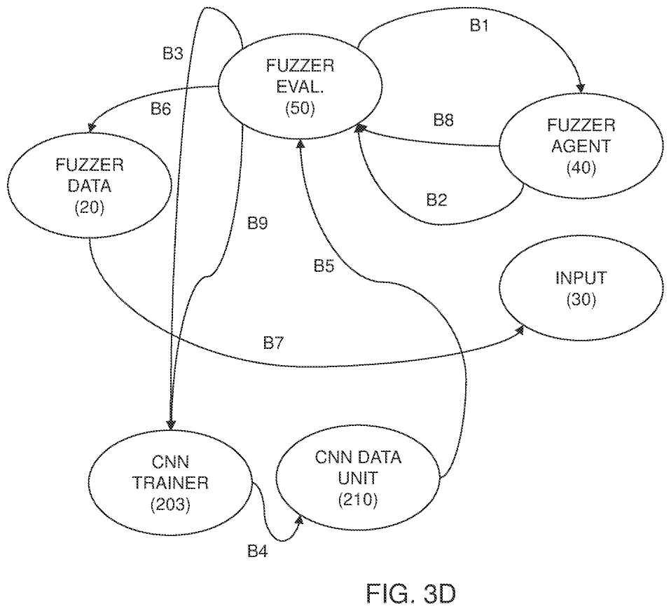

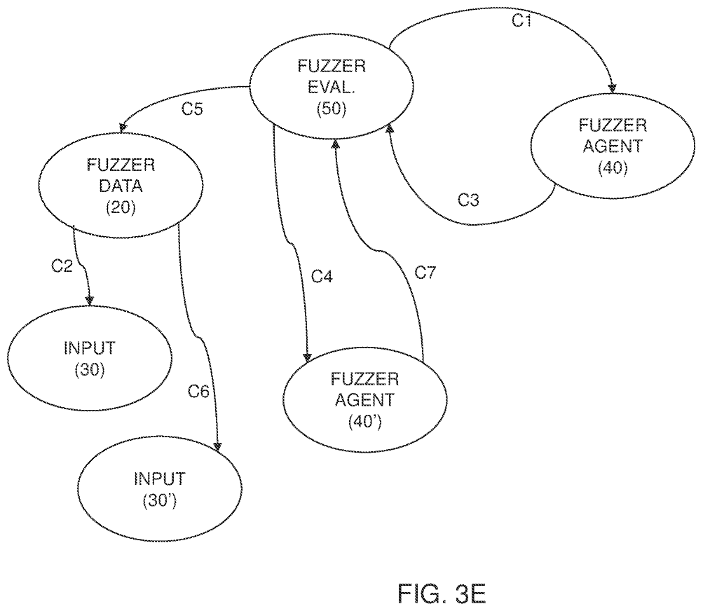

FIG. 3A illustrates a high-level block diagram of a system 215 for fuzzing, in accordance with some examples. System 215 is in all respects similar to system 10, with the addition of ML subsystem 200, an emulator 115′ and an input subsystem 30′. In some examples, input subsystem 30′ comprises instructions which when read by one or more processors cause input subsystem 30′ to access various functions of a process running in emulator 115′. In some examples, emulator 115′ comprises a virtual machine, or other virtual environment (optionally run in a cloud computing environment) that mimics DUT 115. In some examples, emulator 115′ comprises inputs and outputs that simulate the ports and CPU of DUT 115, as known to those skilled in the art. Emulator 115′ comprises a copy 110′ of binary executable file 110 and a fuzzing agent 40′ embedded into copy binary 110′. Input subsystem 30′ directs data to one or more functions within copy 110′ of binary executable file 110. In some examples, as will be described below, fuzzing agent 40′ may be different than fuzzing agent 40. Fuzzing agent 40′ is implemented by a plurality of instructions stored on a memory that when run by one or more processors cause the one or more processors to perform the functions of fuzzing agent 40′.

In some examples, emulator 115′ is implemented by a plurality of instructions stored on a memory that when read by one or more processors cause the one or more processors to implement the functions of emulator 115′.

FIG. 3A illustrates only a single CNN trainer 203 and a single CNN 205, however this is not meant to be limiting in any way and any number of CNNs 205 and respective CNN trainers 203 can be provided without exceeding the scope. In some examples, an output of fuzzer evaluation functionality 50 is in communication with an input of each CNN trainer 203. Although FIG. 3A illustrates a direct connection between fuzzer evaluation functionality 50 and CNN trainer 203, this is not meant to be limiting in any way. In another example (not shown), an additional system is provided to receive the information from fuzzer evaluation functionality 50 and input the information into CNN trainer 203. As described above, each CNN trainer 203 trains a respective CNN 205, and in some examples, the outputs of CNNs 205 are in communication with an input of data unit functionality 210 and the output of data unit functionality 210 is in communication with an input of fuzzer evaluation functionality 50.

In some examples, fuzzer data generator 20 is responsive to an output of the one or more CNNs 205. Particularly, in such an example, data unit functionality 210 transmits to fuzzer evaluation functionality 50 a data unit verified by a CNN 205 as meeting the condition, i.e. that the output of the respective CNN 205 is equal to the comparison value. Fuzzer evaluation functionality 50 then instructs fuzzer data generator 20 to generate such a data unit for input subsystem 30. Fuzzer evaluation functionality 50 then analyzes whether the data unit in fact was able to meet the condition and reach the point of interest. Although the above has been described where data unit functionality 210 transmits the data unit to fuzzer evaluation functionality 50, this is not meant to be limiting in any way. In other examples, data unit functionality 210 can transmit the data unit to fuzzer data generator 20, or to input subsystem 30, without exceeding the scope of the disclosure. Thus, for fuzzing the respective point of interest which has a difficult condition before it, CNNs 205 and data unit functionality 210 provide data units that meet the condition, thereby reaching the respective hook 111.

Fuzzer evaluation functionality 50 then receives the variable value associated with the input data unit and in some examples outputs to CNN trainers 203 an indication whether the respective variable value is equal to the respective comparison value. In some examples, the indication comprises a binary, Boolean or similar value. In another example, the indication comprises the respective variable value and fuzzer evaluation functionality 50 and/or CNN trainers 203 determine whether it is equal to the respective comparison value.

In the event that the respective variable value is equal to the respective comparison value, in some examples training of CNNs 205 is complete. In the event that the respective variable value is not equal to the respective comparison value, that means that the models of CNNs 205 are not accurate, and CNN trainers 203 inputs the respective data unit sent to input subsystem 30 into the one or more CNNs 205 to continue training thereof, i.e. training of CNNs 205.

In some examples, responsive to fuzzer evaluation functionality 50 indicating that the data unit was successful in reaching the point of interest, a second CNN 205′ is trained by a CNN trainer 203′ to generate data units with a high chance of reaching the point of interest, based on the successful data unit described above, as illustrated in FIG. 3B. Particularly, successful data units provided by fuzzer evaluation functionality 50 and/or data unit functionality 210 are used by CNN trainer 203′ (optionally CNN trainer 203′ being one or more CNN trainers 203) to train CNN 205′ such that the trained CNN 205′ generates data units that meet the condition at the point of interest. Thus, in such an example, data units generated by trained CNN 205′ are sent to input subsystem 30, or fuzzer data generator 20, for input into DUT 115.

In some examples, in the event that CNNs 205 don't converge properly, fuzzer evaluation functionality 50 takes a snapshot of the memory stack/heap associated with binary executable file 110 and the registers of the CPU memory. The term “snapshot”, as used herein, means the instructions and values stored in each address from the beginning of the process until the respective point of interest (e.g. memcpy), including the CPU memory registers. Responsive to the snapshot, fuzzer evaluation functionality 50 uses this snapshot for setting the memory of an emulator 115′ to have the same values and state as the CPU's memory at the time of the snapshot, when binary 110 was running in DUT 115. In emulator 115′, fuzzer evaluation functionality 50 inserts various values into the respective variables of a function containing the respective point of interest (e.g. a function containing memcpy and the respective condition), optionally using a CNN until the variable value equals the comparison value.

The above can be utilized, among other things, for: generating rule sets for firewalls; coverage reports (i.e. how much of DUT 115 was tested); and security vulnerability statistics.

FIG. 3C illustrates a diagram describing an example of a first flow of operation of system 215 for fuzzing. In step A1, fuzzer agent 40 sends initialization information to fuzzer evaluation functionality 50. As described above, in some examples the initialization information contained by fuzzer agent 40 was provided by scan functionality 65. In step A2, fuzzer evaluation functionality 50 instructs fuzzer agent 40 to add hooks 111 to the process of binary executable file 110 during run-time.

In step A3, fuzzer evaluation functionality 50 updates fuzzer data generator 20 regarding which bits of each data unit to modify during the fuzzing process. Particularly, as known to those skilled in the art, during fuzzing data units are constantly modified in order to test the system, or portions thereof. Thus, fuzzer evaluation functionality 50 determines which portions of the data units need to be modified for the fuzzing process. The portions can be determined based on: the location of the point of interest being fuzzed, e.g. a portion of the data unit that affects the point of interest; addresses defined in the initialization information as being within the address space of the process; and/or other relevant parameters.

In step A4, fuzzer data generator 20 generates data units based on the received information from fuzzer evaluation functionality 50 and sends the generated data units to input subsystem 30, the data units then input into DUT 115.

In step A5, when the process flow reaches a hook, fuzzer agent 40 sends event information associated with the respective hook 111 to fuzzer evaluation functionality 50. Responsive to the received information, fuzzer evaluation functionality 50 updates fuzzer data generator 20. As will be described below, event information can include, in some examples: information regarding a POI event, i.e. notification that a respective point of interest has been reached; information regarding a coverage event, i.e. notification that a respective block of code has been reached; a CFI event, i.e. notification that a problem has occurred in the control flow, such as detection of a crash, memory corruption, incorrect flow, etc.; and/or information regarding a statistical event, i.e. the counted number of times that the respective hook has been reached or process level statistics, such as the average CPU load, the free stack available memory, the number of page fault interrupts in a second, etc.

Thus, for example, responsive to information regarding a POI event or coverage event, fuzzer evaluation functionality 50 can instruct fuzzer data generator 20 to maintain values in a certain portion of the data units that caused the process to reach the point of interest/block of code, and modify other portions of the data unit for fuzzing purposes. In some examples, responsive to information regarding a CFI event, fuzzer evaluation functionality 50 can instruct fuzzer data generator 20 to update a predetermined portion of the data units such that a different point of interest will be targeted.

In some examples, responsive to information regarding a statistical event, fuzzer evaluation functionality 50 can instruct fuzzer data generator 20 to alter the respective portion of the data units in order to continue the fuzzing process, e.g. if an anomalous statistical event is detected, fuzzer evaluation functionality 50 updates the instruction set/model for modifying the data units such that further statistical events will be caused, and instructs fuzzer data generator 20 to modify the data units accordingly.

FIG. 3D illustrates a diagram describing an example of a second flow of operation of system 215 for fuzzing, using CNN models to overcome a condition check. In some examples, the second flow of FIG. 3D is an extension of the first flow of FIG. 3C, however the second flow can also be separate from the first flow.

In step B1, fuzzer evaluation functionality 50 sends instructions to fuzzing agent 40 to add a hook 111 on a condition check closest to a respective point of interest, i.e. a condition that is checked in order to allow the process to reach the point of interest. The closest condition check is defined as the first condition check preceding the respective point of interest. It is noted that the closest condition check does not have to be immediately preceding the point of interest and there may be one or more instructions between the condition check and the respective point of interest. As described above, in some examples adding hook 111 comprises replacing the opcode of the condition check with a branch instruction to fuzzing agent 40.

In some examples, fuzzer evaluation functionality 50 communicates with fuzzing agent 40 by instructing fuzzer data generator 20 to generate a data unit targeting fuzzing agent 40. For example, the data unit can be a UDP packet whose header contains the IP address and/or port of fuzzing agent 40.

In step B2, when the process reaches the hook 111 of step B1, fuzzing agent 40 sends event information associated with the respective hook 111 to fuzzer evaluation functionality 50, as described above in relation to step A5.

In step B3, responsive to the received information of step B2, fuzzer evaluation functionality 50 sends to CNN trainer 203 relevant information, including: the data unit that caused the process to reach the hook 111, optionally identified by the generated time stamps at input subsystem 30 and at the respective hook 111; and the respective register values, including the comparison value and the variable value, as described above.

In step B4, CNN trainer 203 trains a CNN model using bits of the data unit bits as the input layer and the register values as the output layer. Upon convergence of the model, the model is sent to data unit functionality 210. As described above, in some examples a plurality of CNN trainers 203 run in parallel.

In step B5, data unit functionality 210 runs the model in several parallel instances within the computing environment (e.g. in a cloud computing environment), using random input bits for each instance. Responsive to reaching a desired output, i.e. a data unit which causes the output variable value of the model to be equal to the comparison value, the input bits are sent to fuzzer evaluation functionality as a data unit candidate.

In step B6, fuzzer evaluation functionality 50 instructs fuzzer data generator 20 to send the data unit candidate to input subsystem 30. In step B7, fuzzer data generator 20 sends the data unit candidate to input subsystem 30.

In step B8, when the process flow reaches the hook 111 of steps B1 and B2, fuzzing agent 40 sends event information associated with the respective hook 111 to fuzzer evaluation functionality 50, as described above, including the variable value(s). In some examples, fuzzer evaluation functionality 50 compares the variable value(s) to the comparison value(s), and if the condition is met, fuzzing agent 40 branches to the next opcode in order to continue the process flow, until reaching the respective point of interest. In such a case, the data unit candidate is defined by fuzzer evaluation functionality 50 as a verified data unit, and the verified data unit is used as a basis for subsequent iterations of data units for reaching the next block or point of interest.

In step B9, fuzzer evaluation functionality 50 send the verified data unit to CNN trainer 203′ to train CNN model 205′ to generate data units similar to the verified data unit, i.e. data units that produce the same conditions to overcome the condition check. In the event that the data unit candidate does not overcome the condition check, fuzzer evaluation functionality 50 sends the variable value(s) that were achieved by the data unit candidate to CNN trainer 203, and CNN trainer 203 uses this information to continue training CNN model 205.

FIG. 3E illustrates a diagram describing an example of a third flow of operation of system 215 for fuzzing, using CNN models to perform function-level fuzzing. In some examples, the third flow of FIG. 3E is an extension of the first flow of FIG. 3C and/or second flow of FIG. 3D, however the third flow can also be separate from the first and second flows.

In step C1, fuzzer evaluation functionality 50 sends instructions to fuzzing agent 40 to add a hook 111 at an entry point of a predetermined function. In step C2, fuzzer data generator 20 sends data units to input subsystem 30, which then inputs the data units into DUT 115. As described above, the data units are generated to target the respective function.

In step C3, when the process flow reaches the respective hook 111, fuzzing agent 40 sends event information associated with the respective hook 111 to fuzzer evaluation functionality 50, as described above in relation to steps A5 and B2.

In step C4, upon receiving the event information, fuzzer evaluation functionality 50 sends a memory snapshot to fuzzing agent 40′. In some examples, the memory snapshot is sent to fuzzing agent 40′ via input subsystem 30′, as described above in relation to communication between fuzzer evaluation functionality 50 and fuzzing agent 40. In another example, fuzzer evaluation functionality 50 communicates directly with fuzzing agent 40′. Responsive to the received snapshot, fuzzing agent 40′ initiates function-level fuzzing within emulator 115′, as will be further described below. In some examples, responsive to the received memory snapshot, fuzzing agent 40′ sets the respective values of emulator 115′ to the corresponding values of DUT 115 such that data units input at input subsystem 30′ will arrive at the respective function of step C1. In some examples, the set values include the register values from the memory snapshot. In some examples, where emulator 115′ is a QEMU emulator, a protocol such as a QEMU Machine Protocol (QMP) is used to set the register values.

In step C5, fuzzer evaluation functionality 50 controls fuzzer data generator 20 to generate and send data units to input subsystem 30′ and in step C6 fuzzer data generator 20 generates and sends the data units to input subsystem 30′. The generated data units are aimed at fuzzing the respective function, i.e. the relevant portions of the data units are continuously modified to fuzz the respective function.

In step C7, fuzzing agent 40′ sends event information associated with the respective function to fuzzer evaluation functionality, as will further be described below.

In some examples, evaluation functionality 50 generates one or more reports regarding CFI events and statistical events. The generated reports can be stored in a database and/or transmitted to an external system/server.

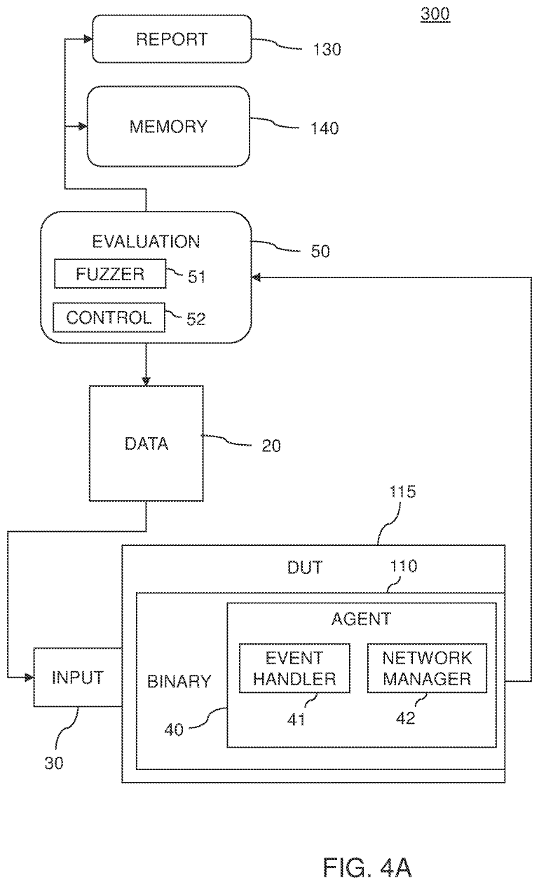

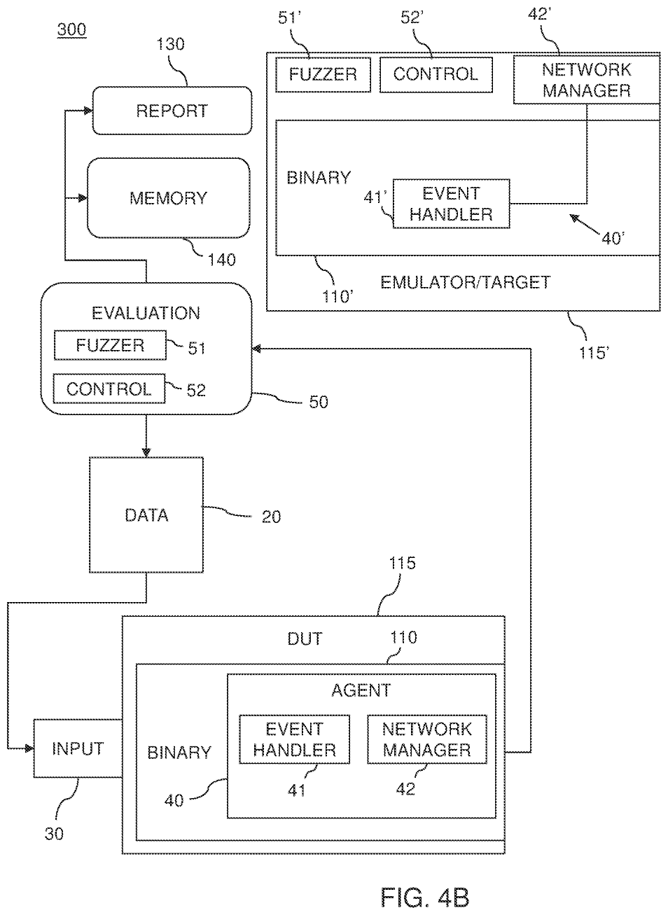

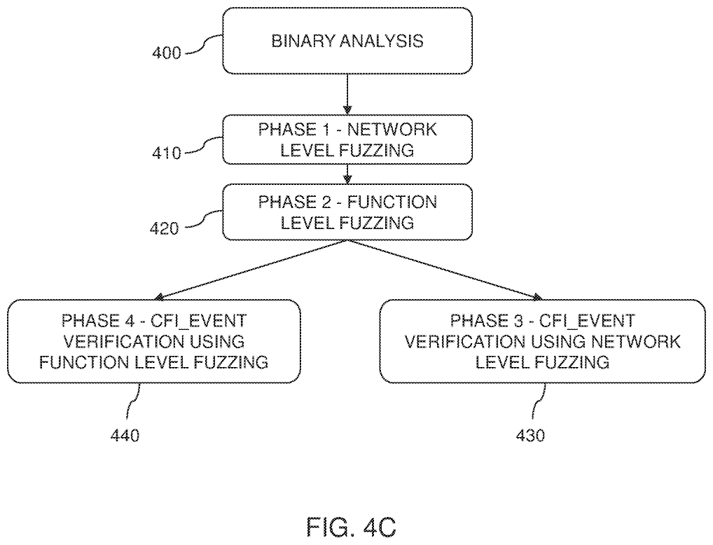

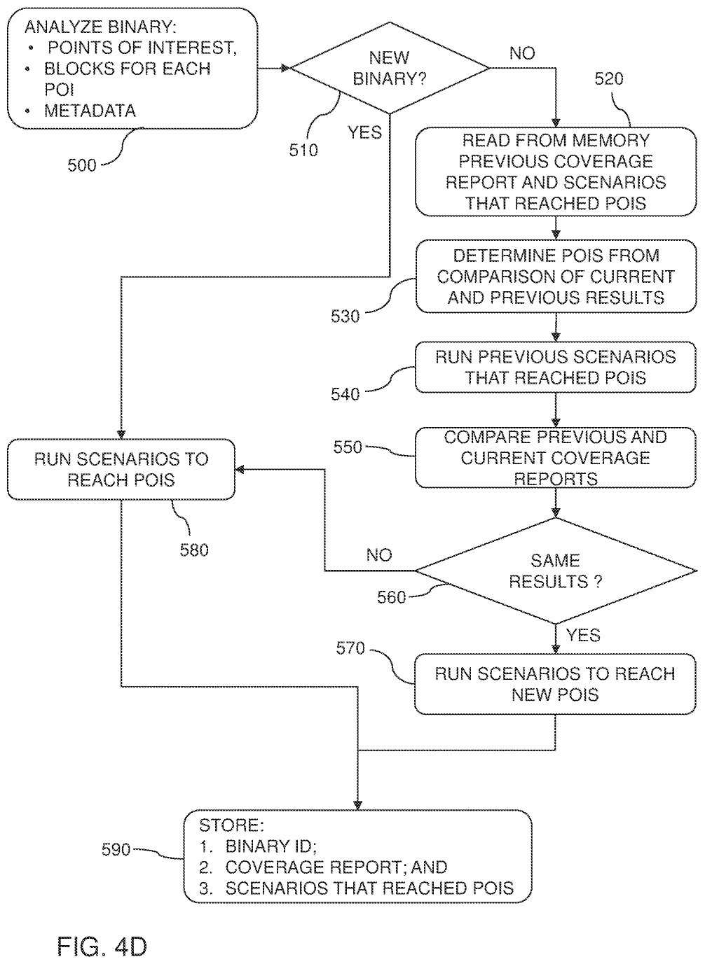

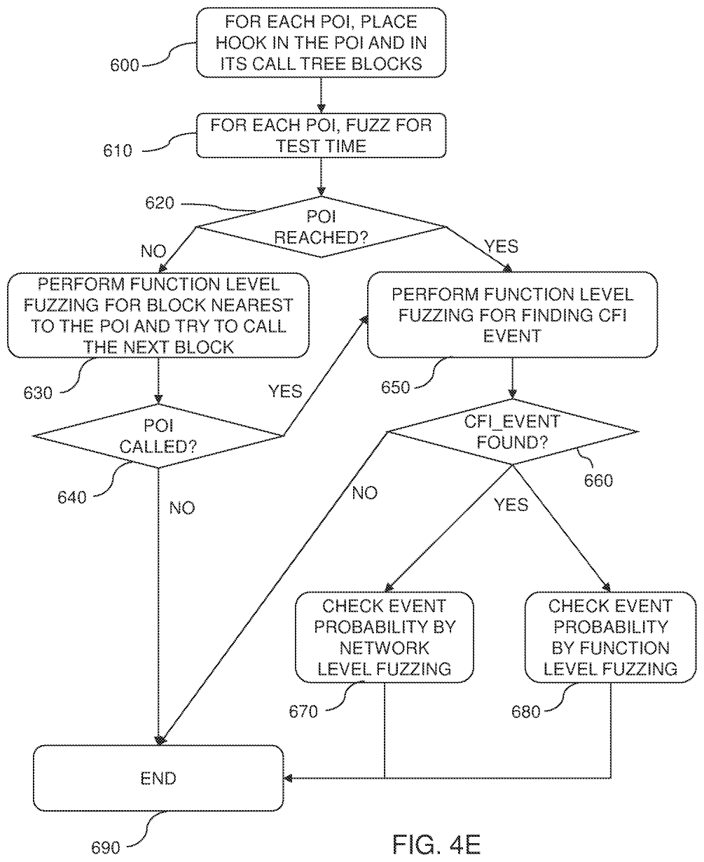

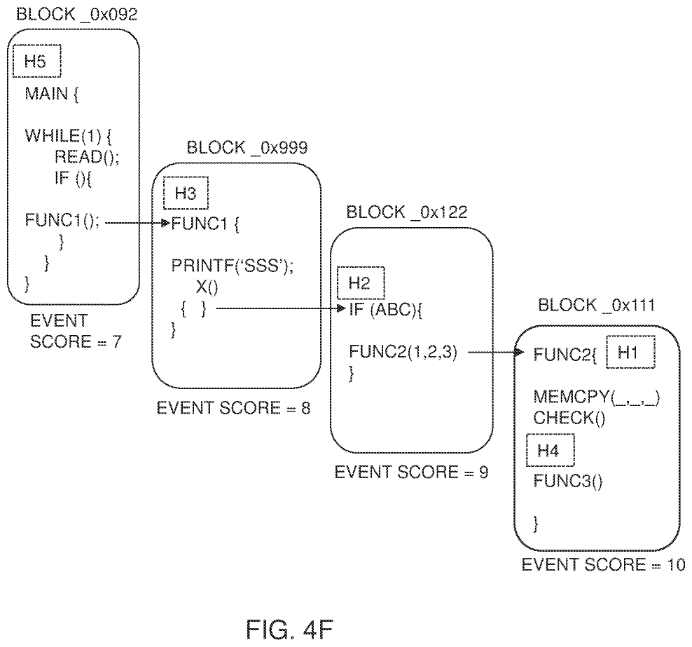

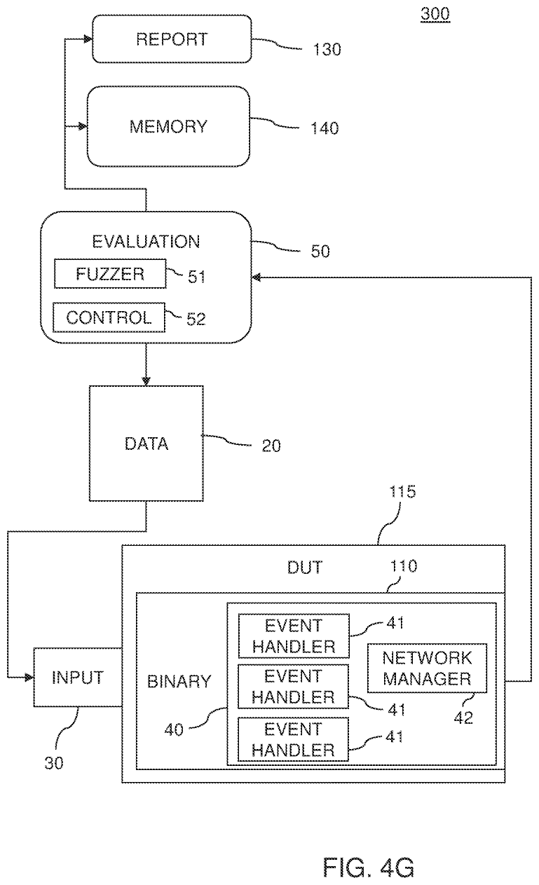

FIG. 4A illustrates a high-level block diagram of an example of a system 300 for fuzzing and FIG. 4B illustrates a high-level block diagram of a more detailed example of system 300 for fuzzing.

In some examples, system 300 comprises: a fuzzer data generator 20; an input subsystem 30; a fuzzing agent 40 embedded within a binary executable file 110, binary executable file 110 initialized to run on DUT 115; a fuzzer evaluation functionality 50; a report functionality 130; and a memory 140. Although not illustrated, various timestamp generators may be provided, as described above in relation to system 10. Fuzzing agent 40 is implemented as described above, however FIG. 4A illustrates an example where fuzzing agent 40 comprises an event handler 41 and a network manager 42. In some examples, as illustrated in FIG. 4G, fuzzing agent 40 comprises a plurality of event handlers 41. Although three event handlers 41 are illustrated, this is not meant to be limiting in any way, and in another example any number of event handlers 41 can be provided, without exceeding the scope of the disclosure.

Fuzzer evaluation functionality 50 is implemented as described above, however FIG. 4A illustrates an example where fuzzer evaluation functionality 50 comprises a fuzzing unit 51 and a control unit 52.

In some examples, event handler 41 is implemented by a plurality of instructions stored on a memory (optionally memory 140), which when run by one or more processors cause the one or more processors to perform the functions of event handler 41. In some examples, the one or more processors are implemented as part of DUT 115. In some examples, network manager 42 is implemented by a plurality of instructions stored on a memory (optionally memory 140), which when run by one or more processors cause the one or more processors to perform the functions of network manager 42. In some examples, the one or more processors are implemented as part of DUT 115. In some examples, event handler 41 and network manager 42 are implemented on the same one or more processors. In some examples, network manager 42 implements a UDP server configured to listen to one or more predetermined ports.

In some examples, fuzzing unit 51 is implemented by a plurality of instructions stored on a memory (optionally memory 140), which when run by one or more processors cause the one or more processors to perform the functions of fuzzing unit 51. In some examples, control unit 52 is implemented by a plurality of instructions stored on a memory (optionally memory 140), which when run by one or more processors cause the one or more processors to perform the functions of control unit 52.

In some examples, report functionality 130 is implemented by a plurality of instructions stored on a memory (optionally memory 140), which when run by one or more processors cause the one or more processors to perform the functions of report functionality 130. In some examples, report functionality 130 is in communication with an external system or server. In some examples, report functionality 130 comprises a memory or is in communication with memory 140.

In some examples, memory 140 (and similarly memory 80 described above) comprises a persistence memory, i.e. non-volatile memory, such as a solid-state drive (SSD), a NAND flash drive, a ferroelectric RAM, etc. In some examples, memory 140 (and similarly memory 80 described above) is implemented as a respective portion of the memory that is used for DUT 115.

In some examples, as illustrated in FIG. 4B, system 300 for fuzzing further comprises: an emulator 115′; a fuzzing agent 40′; a fuzzing unit 51′; and a control unit 52′. Fuzzing agent 40′ comprises an event handler 41′ and a network manager 42′. A copy 110′ of binary executable file 110 is implemented on emulator 115′.

In some examples, event handler 41′ is implemented by a plurality of instructions stored on a memory (optionally memory 140), which when run by one or more processors cause the one or more processors to perform the functions of event handler 41′. In some examples, network manager 42′ is implemented by a plurality of instructions stored on a memory (optionally memory 140), which when run by one or more processors cause the one or more processors to perform the functions of network manager 42′. In some examples, network manager 42′ can include a network socket configured for network communication, as described below.

In some examples, fuzzing unit 51′ is implemented by a plurality of instructions stored on a memory (optionally memory 140), which when run by one or more processors cause the one or more processors to perform the functions of fuzzing unit 51′. In some examples, control unit 52′ is implemented by a plurality of instructions stored on a memory (optionally memory 140), which when run by one or more processors cause the one or more processors to perform the functions of control unit 52′. In some examples, event handler 41′, network manager 42′, fuzzing unit 51′ and control unit 52′ are each implement by the same one or more processors that implement emulator 115′.

In some examples, event handler 41′ is embedded within binary copy 110′, while network manager 42′, fuzzing unit 51′ and control unit 52′ are implemented within emulator 115′, yet not embedded within binary copy 110′. In some examples, network manager 42′ communicates with event handler 41′ using a shared memory between two processes.

Although systems 215 and 300 are described in an example as comprising one or more emulators 115′, this is not meant to be limiting in any way. Alternatively, or additionally, system 215 and/or 300 can comprise one or more virtual machines, such as an AWS Graviton server, commercially available from Amazon Web Services. In the event that binary 110 calls a function that is not supported by the virtual machine, the function can be replaced with a compatible function that mimics the operation of the original function.

FIG. 4C illustrates a high-level flow chart of an example of a method of fuzzing. In some examples, the described method of fuzzing is implemented using system 300, however this is not meant to be limiting in any way. In step 400, binary executable file 110 is analyzed to determine relevant information. As described above, the analyzation can include identifying: a list of points of interest; addresses of opcodes, each opcode preceding a respective point of interest and being an opcode of a condition check (i.e. a comparison of a variable to a predefined value); a list of interesting strings, such as service numbers, port numbers, keys, etc.; and a list of software stack characteristics, such as the stack being a transmission control protocol (TCP) stack, an internet protocol (IP) stack, a crypto library, etc. In some examples, as described above, the analyzation is performed by scan functionality 65 (not shown for simplicity). In another example (not shown), as described above, the analyzation is performed by fuzzer evaluation functionality 50, particularly by control unit 52.

In some examples, as described above, binary executable file 110 is analyzed to define points of interest. As described above, in some examples, the defined points of interest are functions of a predetermined type. In another example, alternatively or additionally, indications of points of interest are received from a user input.

In some examples, binary executable file 110 is analyzed to identify a block graph for each point of interest. Particularly, if there are one or more blocks of code that lead up to the respective point of interest, these blocks of code are identified. For example, as illustrated in FIG. 4F. FUNC2 is a function defined as a point of interest. As shown, in order to reach FUNC2, the process begins from BLOCK_0x092, and goes through BLOCK_0x099 and BLOCK_0x122 until reaching BLOCK_0x111 which contains FUNC2. The term “block of code”, as used herein, means a plurality of lines of code grouped together. The numbers shown (0x092, 0x099, 0x122 and 0x111) indicate the memory address of the first opcode in the block of code. In some examples, a block of code is defined as a plurality of instructions that begin with a branch instruction and end with a branch instruction.

In some examples, certain metadata (e.g. certain strings) is identified within binary executable file 110.

Binary executable file 110 is instrumented to be added to DUT 115. As described above, in some examples, fuzzing agent 40 is embedded within the instrumented binary. As described above, in some examples, fuzzing agent 40 comprises: code to implement network manager 42, optionally code to send and receive UDP packets, i.e. code; hooks inserted into binary executable file 110 upon initialization; code to implement event manager 41 and optionally store information; code to add hooks during run-time; or any combination of the above options.

In some examples, a user input is received at fuzzer evaluation functionality 50, the user input defining: the number of data units to be sent for each point of interest; and/or the maximum time allowed for fuzzing each point of interest. In some examples, a user input is received at fuzzer evaluation functionality 50, the user input defining traffic configuration information regarding the allowed traffic policy to DUT 115. In some examples, a user input is received at fuzzer evaluation functionality 50, the user input comprising TARA information regarding binary executable file 110. Any, or a combination of, the above user inputs can be received at fuzzer evaluation functionality 50.

In step 410, in phase 1, network-level fuzzing is performed, as will be described below. In step 420, in phase 2, when the process flow reaches a point of interest, that point of interest is fuzzed using function-level fuzzing, as will be described below. Responsive to detection of a CFI event in the function-level fuzzing of phase 2 (step 420), the probability of the CFI event actually occurring is checked both in: step 430, using network-level fuzzing, as will be described below; and step 440, using function-level fuzzing, as will be described below.

FIG. 4D illustrates a high-level flow chart of a flow of part of the operation of a fuzzing method. The method is described in relation to system 300, however this is not meant to be limiting in any way. In step 500, binary executable file 110 is analyzed, as described above in relation to step 400.

In step 510, scan functionality 65 (not shown) or control unit 52 of fuzzer evaluation functionality 50 determine whether binary executable file 110 is new or whether it has been fuzzed before by system 300. In the event that it is determined that binary executable file 110 is not new (i.e. it has previously been fuzzed by system 300), data is extracted from memory 140 and/or report functionality 130 regarding: previous coverage reports, e.g. reports on which points of interest were previously reached, and how often they were reached; and/or scenarios that reached particular points of interest, e.g. reports regarding data units that were successful in reaching the respective points of interest.

In step 520, in some examples, a list of new points of interest is generated based on a comparison of the analysis of step 500 with the results of the previous fuzzing session, or sessions. Particularly, in some examples, points of interest which were not yet reached in previous fuzzing sessions are defined. In another example, both new points of interest and previously fuzzed points of interest are defined in the list.

In step 540, utilizing the information of step 510, control unit 52 of fuzzer evaluation functionality 50 instructs fuzzing unit 51 to perform control fuzzer data generator 20 to use data units that were previously successful in reaching certain points of interest. Control unit 52 then determines a coverage report of the fuzzing, i.e. how many of the defined points of interest were reached and how many times they were reached. In step 550, the currently determined coverage report is compared to the previous coverage report, or coverage reports.

In step 560 it is determined whether the coverage reports are the same. In the event that an outcome of the comparison indicates that the coverage reports are the same, or that the difference is less than one or more predetermined thresholds, in step 570 control unit 52 instructs fuzzing unit 51 to fuzz new points of interest, i.e. points of interest that weren't fuzzed before.

In the event that an outcome of the comparison of step 550 indicates that the coverage reports are not the same, or that the difference is not less than the one or more predetermined thresholds, in step 580 control unit 52 instructs fuzzing unit 51 to again fuzz all the points of interest in the list, including previously fuzzed points of interest. Similarly, if an outcome of the comparison of step 510 indicates that binary executable file 110 hasn't been fuzzed before, no points of interest are skipped.

In step 590, after the fuzzing of step 570, and/or step 580, control unit 52 controls report functionality 130 to store information regarding the fuzzing session, optionally including: an identifier of binary executable file 110; a coverage report determined by control unit 52; scenarios that reached respective points of interest, i.e. certain data unit that reached the respective points of interest; or any combination thereof.

FIG. 4E illustrates a high-level flow chart of a flow of part of the operation of a fuzzing method. The method is described in relation to system 300, however this is not meant to be limiting in any way. In step 600, as described above in relation to step 410, for each defined point of interest, a respective hook is placed at the point of interest. In some examples, a hook is also added at the beginning of each block of code that is in the call tree of the respective point of interest. In some examples, each hook is added by fuzzing agent 40. In another example, one or more hooks are added by control unit 52 of fuzzer evaluation functionality 50 and/or scan functionality 65.

In some examples, where fuzzer evaluation functionality 50 instructs fuzzing agent 40 to add hooks, fuzzer evaluation functionality 50 sends a message (such as a UDP message) to fuzzing agent 40, via input subsystem 30, the message containing the addresses of the locations for placing hooks. In some examples, network manager 42 of fuzzing agent 40 receives the message and fuzzing agent 40 then parses the received message to find the address offsets of the blocks of code and of the points of interest. In some examples, fuzzing agent 40 then adds a base address (such as an ASLR base address) to the address offsets to identify the actual memory addresses of the blocks of code and of the points of interest.

In some examples, fuzzing agent 40 changes the access permissions of the text section of binary executable file to “write”. In some examples, where DUT 115 is a Linux system, changing the access permission is performed using the Mprotect application programming interface (API). In another example, where DUT 115 is an embedded system, changing the access permission is performed using the memory protection module API.

In some examples, as described above, fuzzing agent 40 adds a hook by replacing the opcode at the respective address with a branch command to event handler 41. In some examples, where a plurality of event handlers 41 are provided, each event handler 41 is associated with a respective one of a plurality of event types. For example, as described above, the event types can include a POI event, a coverage event, a CFI event and a statistical event.

In such an example, fuzzing agent 40 comprises four event handlers 41-a first event handler 41 associated with POI events, a second event handler 41 associated with coverage events, a third event handler 41 associated with CFI events and a fourth event handler 41 associated with statistical events.

Similarly, each hook branches to a respective event handler 41 depending on the type of hook. For example: POI event hooks are placed at points of interest (e.g. hook H1 in FIG. 4F) and thus branch to the event handler 41 associated with POI events; coverage event hooks are placed at the beginning of blocks of code (e.g. hooks H5, H3 and H2 in FIG. 4F) and thus branch to the event handler 41 associated with coverage events; and CFI event hooks are placed at points that have the potential for control flow or security errors (e.g. hook H4 in FIG. 4F).

In some examples, CFI event hooks are added after a POI event hook is reached. Particularly, in such an example, the respective event handler 41 receives an indication from a POI event hook that the respective point of interest has been reached. Responsive to receipt of such an indication, fuzzing agent 40 adds a CFI event hook to the respective portion of code. In some examples, fuzzing agent 40 removes the POI event hook that was reached and replaces it with a CFI event in the same location. Thus, in such an example, the POI event hook is used to identify when the process flow arrives at the point of interest and the CFI event hook is used for the actual fuzzing of the respective point of interest to detect a CFI event.

In some examples, the branch instruction of each hook comprises a branch-with-link instruction. As known to those skilled in the art, a branch-with-link instruction branches to a predetermined address, while saving the return address. In some examples, the return address for each hook is stored, along with the respective opcode that the hook replaced, thus fuzzing agent 40 can remove the respective hook and return the replaced opcode to its original address.

In some examples, the opcode replaced by the respective hook is stored within the respective event handler 41. In such an example, upon arriving at the respective hook, the process branches to the respective event handler 41 and then the respective event handler 41 identifies the location of the respective hook. In some examples, the hook is identified by comparing the return address received from the branch-with-link instruction to a table containing the return addresses of the replaced opcodes. In such an example, the replaced opcode is then performed inside the respective event handler 41. For example, for an opcode which comprises a comparison of the value of a register to a predetermined value, the respective event handler 41 performs the respective comparison and then returns to the appropriate return address. Advantageously, running the replaced opcode inside the respective event handler 41 is faster than storing the replaced opcode in a different location, finding that location, and branching to that location to perform the opcode.

In some examples, each event handler 41 is a function, and at the end of execution of the function it returns to the caller. In such an example, the respective event handler adjusts the return address so that it continues to the next opcode, i.e. the return address is offset by the number of bytes between each opcode. For example, in an ARM32 environment, where the return address is 0x100, the return address will be adjusted to 0x104.

In another example, the replaced opcodes are stored in a different memory address, and the respective event handler 41 branches to the appropriate address to arrive at the replaced opcode.

As described above, in some examples, when a certain type of hook is reached, such as a coverage event type hook, the respective event handler 41 removes the hook and puts the replaced opcode back where it originally was.

In step 610, for each point of interest, a particular point of interest is fuzzed for a predetermined test time. In some examples, the time it takes to reach the point of interest (which may take time if there are condition checks along the way) is included within the maximum allowed test time. In another example, the predetermined test time is defined as the maximum allowed time for attempting to arrive at a point of interest.

As described above, fuzzing unit 51 controls fuzzer data generator 20 to supply data units to input subsystem 30. In some examples, fuzzing unit modifies data units for fuzzing in accordance with a genetic algorithm, or other suitable fuzzing algorithm, as known to those skilled in the art.

In some examples, fuzzer evaluation functionality 50 has the following possibilities for receiving information from network manager 42 of fuzzing agent 40 following the insertion of a data unit through input subsystem 30: A. no information is received, i.e. no hook was reached; B. information indicating a POI event; C. information indicating a coverage event; or D. information indicating a CFI event. For each data unit that is sent, network manager 42 may receive information regarding a plurality of hooks reached. In some examples, control unit 52 stores information regarding the initiated events in a buffer, and after the predetermined test time, or after a predetermined number of hooks have been reached, the information within the buffer is stored in memory 140.

In some examples, each hook has a respective score in relation to the respective point of interest. In some examples, coverage event hooks have a score associated with the distance from the point of interest. For example, for the hooks shown in FIG. 4F, hook H5 (which is a coverage event hook) has a score of 1 in relation to the point of interest FUNC2, since it is in the first block of code in the call tree of FUNC2. Similarly, hook H3 (which is a coverage event hook) has a score of 2, since it is in the second block of code in the call tree of FUNC2. Similarly, hook H2 (which is a coverage event hook) has a score of 3, since it is in the third block of code in the call tree of FUNC2. Although the above has been described in an example where the closer a coverage event hook is to the point of interest, the higher its score, this is not meant to be limiting in any way. In another example, a POI event hook (such as hook H1) has a higher score than coverage event hooks and a CFI event hook (such as hook H4) has a higher score than a POI event hook. Table illustrates an example of the event hooks of FIG. 4F:

TABLE 1

| Timestamp | Address | Name | Type | Score |
|---|---|---|---|---|
| 23232314 | 0x1112 | H1 | POI | 4 |
| 23232313 | 0x998 | H2 | Coverage | 3 |
| 23232312 | 0x92298 | H3 | Coverage | 2 |
| 23232315 | 0x0332 | H4 | CFI | 20 |
| 23232311 | 0x982 | H5 | Coverage | 1 |

where the timestamp indicates the timestamp generated upon arrival of the process at the respective hook, as described above, and the address shows the address of the hook. The scores are used by fuzzer evaluation functionality 50 for generating the coverage report and/or for adjusting the fuzzing of the point of interest, as will be described below.

In some examples, for identifying how much coverage has been achieved, a total coverage score is defined as a predetermined function of the different coverage event hooks reached, where the differently scored coverage event hooks exhibit different weights. In some examples, the total coverage score is determined for each data unit. In another example, the total coverage store is determined at the end of the fuzzing session to determine the achieved coverage.

In some examples, the coverage score is determined as follows:
A. Reaching a hook with a level 1 hook is defined with a predetermined score. A level 1 hook is defined as a coverage event hook that is further from the point of interest (hook H5 in FIG. 4F). The score of the level 1 hook is denoted ‘score_level_1_hook’.
B. ‘Score_level_2_hook’ is defined as: (number of level 1 hooks)*score_level_1_hook+1.
C. ‘Score_level_3_hook’ is defined as: (number of level 1 hooks)*score_level_1_hook+ (number of level 2 hooks)*score_level_2_hook+1. A level 2 hook is defined as a coverage event hook that is in the second block of code in the call tree of the point of interest (hook H3 in FIG. 4F).
D. The scores for each level are further defined in accordance with the above.
   Thus, each event has its own score and the data units can be adjusted in accordance with the score of each event to reach the respective point of interest.

In accordance with the received information regarding the hook reached, fuzzing unit 51 adjusts the data units of fuzzer data generator 20 accordingly. For example, for each POI, in step 620, control unit 52 of fuzzer evaluation functionality 50 determines whether the respective point of interest has been reached, i.e. whether a POI event associated with the respective point of interest has been initiated.

In the event that control unit 52 determines that the respective point of interest has not been reached by the respective data unit, in step 630 function-level fuzzing is performed for the block of code closest to the respective point of interest. For example, if the point of interest is at hook H1 of FIG. 4F, function-level fuzzing is performed for block 0x122. In some examples, the closest block of code is identified in accordance with the score of the coverage hook at the beginning of the respective block of code. For example, the coverage event hook exhibiting the highest score (or second-to-highest score) will be in the block of code immediately preceding the block of code containing the point of interest.

In some examples, function-level fuzzing by fuzzing agent 40 creates a snapshot of the target CPU internal state (registers and memory) and sends the snapshot to fuzzer evaluation functionality 50. In some examples, in the case of a hardware dependent function (e.g. an ECU peripheral), relevant peripheral information is sent by fuzzing agent 40 to be used by the function-level fuzzing to mock the hardware dependent function.

In some examples, control unit 52 of fuzzer evaluation functionality 50 sends the snapshot information and optionally other additional information to network manager 42′ of fuzzing agent 40′ running in emulator 115′. In some examples, the additional information comprises any of: the address of the point of interest; the number of pointer bytes being copied; or whether a CFI event has been detected.

In some examples, in the case that there is a function being fuzzed, and a hardware dependency that is not emulated, instead of crashing or stopping the function level fuzzing because of the lack of hardware dependency, control unit 52′ requests from fuzzer evaluation functionality 50 to perform network-level fuzzing on DUT 115 until it reaches the function that calls the hardware dependency, then fuzzing agent 40 sends the hardware dependency information to fuzzer evaluation functionality 50. Control unit 52 of fuzzer evaluation functionality 50 then forwards this information to control unit 52′ in emulator 115′. Control unit 52′ then updates fuzzing agent 40′ to mock the hardware dependent function, and when the hardware dependency is called, fuzzing agent 40′ returns the hardware dependency values (received from DUT 115) to the function.

In one embodiment, function-level fuzzing is performed using common utilities for function level fuzzing such as AFL or libfuzzer. In some examples, fuzzing agent 40′ wraps the function under test (FUT) and monitors its status (Run time duration, return values, memory, etc.).

In some examples, control unit 52′ controls fuzzer unit 51′ to input values into the respective block of code in order to reach the point of interest. In the event that the block of code includes one or more condition checks, values are input until the correct values for overcoming the condition check (or condition checks) are found. Thus, control unit 52′ and fuzzer unit 51′ continue to perform function-level fuzzing until the point of interest is reached.

After completion of the function-level fuzzing, network manager 42′ sends the values that were used to reach the point of interest to fuzzer evaluation functionality 50. Fuzzer evaluation functionality 50 then uses these values to control fuzzer data generator 20 to generate data units containing these values. Particularly, in some examples, data units are repeatedly updated and sent until the achieving the determined argument values of the respective function. In some examples, fuzzer evaluation functionality comprises a predetermined algorithm for updating data units in response to changes in the function arguments such that the difference between the function arguments and the determined argument values keep getting smaller.

In step 640, fuzzer evaluation functionality 50 then again checks whether the point of interest was reached.

In the event that the point of interest was reached, either in step 630 or step 610, in step 650 function-level fuzzing is performed for identifying a CFI event. Advantageously, performing function-level fuzzing is faster than performing network-level fuzzing. Therefore, identifying a CFI event in function-level fuzzing will be faster than identifying a CFI event in network-level fuzzing. Additionally, while function-level fuzzing is being performed for identifying a CFI event, network-level fuzzing can be continued for identifying other POI events.

During the function-level fuzzing, control unit 52′ and fuzzing unit 51′ fuzz the point of interest (e.g. a function) with varying function arguments to identify abnormal events, such as memory corruptions, running duration greater than a predetermined time threshold, attempts to access non-allowed memory (e.g. segfault), etc.

In some examples, event handler 41′ stores the function arguments that caused the event in a dedicated buffer. In some examples, the function arguments are stored along with identifiers of their respective registers. Since an argument of a function can be a pointer, in some examples event handler 41′ verifies that each argument value is a legitimate address in the memory space. In the event that the process memory has such value as an address, event handler 41′ copies a respective number of bytes from the address to a buffer. In some examples, the respective number of bytes is a predetermined number defined in advance.

In some examples, the function arguments are stored in the memory or is sent by network manager 42′ to fuzzer evaluation functionality 50. In some examples, the decision whether to store the event information or to send it is based on configuration information received at the start of the function-level fuzzing. In some examples, the function-level fuzzing of the point of interest runs until the predetermined test time has elapsed. In the event that upon each CFI event the function arguments Thus, fuzzer evaluation functionality 50 now contains the register values which can be used to cause a CFI event at the point of interest.

In step 660, fuzzer evaluation functionality 50 determines whether a CFI event happened during the function-level fuzzing. In the event that at least one CFI event occurred, the probability of the CFI event actually occurring is checked separately in steps 670 and 680, as described above in relation to steps 430 and 440. In other words the CFI event is verified to determine whether it is a real CFI event, or only theoretical. Particularly, step 430 corresponds to step 670 and step 440 corresponds to step 680. Although both steps 670 and 680 are described as being performed, this is not meant to be limiting in any way. In another example, only one of steps 670 or 680 are performed. In another example, each point of interest has defined therefor which of steps 670 or 680 should be performed, or whether both should be performed. In another example, for one or more points of interests, neither of steps 670 or 680 are performed.

In step 670, the probability of occurrence of a CFI event is checked using network-level fuzzing. Particularly, in some examples, fuzzer evaluation functionality 50 has previously received the function arguments that cause the CFI event, as described above. These function arguments are used as target values. In some examples, fuzzer evaluation functionality 50 instructs fuzzing agent 40 to add an information-leak event hook at the beginning of the block of code containing the point of interest (BLOCK_0X111 in FIG. 4F). The term “information-leak event hook”, as used herein, means a hook that copies the argument values of the function from their respective registers or memory addresses. For example, in an ARM32 instruction set, the function argument values are typically stored in registers r0, r1, r2, etc. In some examples, placing the information-leak event hook at the beginning of the block code can provide more resolution since functions can include a plurality of blocks of code. However, this is not meant to be limiting in any way. In some examples, one or more information-leak event hooks are placed at the beginning of a respective function.

In some examples, fuzzer evaluation functionality 50 starts the network-level fuzzing by instructing fuzzer data generator 20 to start the fuzzing session using the data units that reached the point of interest in step 620 (or 640).

Responsive to arriving at the respective information-leak event hook, in some examples the hook branches to a respective event handler 41 associated with information-leak event hooks. In some examples, the respective event handler 41 updates the event buffer with the current function argument values. In some examples, fuzzing agent 40 sends the event data received from the information-leak event hook to fuzzer evaluation functionality 50.

In some examples, fuzzer evaluation functionality 50 uses the event information as scoring values for an optimization algorithm for updating the data units. In some examples, the optimization algorithm comprises a genetic algorithm, such as an adaptive heuristic search algorithm. In another example, other optimization algorithms can be used, such as the algorithm provided by libfuzzer, commercially available from Google LLC of Mountain View, California, USA.

In some examples, a distance value is defined by comparing the current argument values with the target argument values received from emulator 115′. The distance value acts as the score of the data unit. For each data unit that is sent and arrives at the point of interest, the current argument values are compared to the target argument values and the distance value therebetween is defined as the score of the respective data unit. The optimization algorithm (in fuzzing unit 51) uses this feedback mechanism and scoring to find one or more data units that can lead to argument values that are equal to the target argument values.

In the event that the predetermined test time has elapsed and no such data unit has been found, the data unit with the lowest score (i.e. the lowest distance value) is reported by fuzzer evaluation functionality 50 in step In the case the fuzzing session time is elapsed and no packet is found, the data unit with the highest score is reported/stored in step 690. In the event that such a data unit is found, the respective data unit is reported/stored in step 690. In some examples, control unit 52 of fuzzer evaluation functionality 50 stores all data units and their scores in memory 140.

In step 680, the probability of occurrence of a CFI event is checked using function-level fuzzing. In some examples, fuzzer evaluation functionality 50 instructs fuzzing agent 40 to add a coverage event hook in the beginning of the block of code that calls the block of code comprising the point of interest, as described above in relation to step 630. In some examples, as described above, instructions from fuzzer evaluation functionality 50 to fuzzing agent 40 are sent via a packet targeting the IP and PORT of fuzzing agent 40, and the payload of the packet comprises the address where the hook should be placed and the type of hook to be placed.

When the process flow reaches the new hook, in some examples fuzzing agent creates a snapshot of the memory space and sends it to fuzzer evaluation functionality 50, as described above. As described above, fuzzer evaluation functionality 50 sends the snapshot information, and optionally other additional information, to network manager 42; running in emulator 115′.

Fuzzing unit 51′ then performs function-level fuzzing (as described above) to try to find function parameters that were found to cause the CFI event. Particularly, the goal of this phase is to find cases where the previous block of code calls the POI block (i.e. the block of code containing the point of interest) with the same parameters that caused the CFI event.

In some examples, fuzzing unit 51′ tests different sets of arguments of the previous blocks of code, and uses the values of the arguments from the CFI event as the target. In some examples, the difference between the current values that are sent to the POI block and the values found in the CFI event is defined as the respective score. In some examples, fuzzing unit 51′ applies an algorithm aimed at maximizing the score by altering the values.

If a predetermined time period has elapsed without finding such argument values that call the POI block, control unit 52′ updates fuzzer evaluation functionality 50 that the arguments weren't found. In the event that such argument values are found, control unit 52′ updates fuzzer evaluation functionality 50 with the identified argument values. In some examples, the network-level fuzzing of step 670 is then performed, as described above, based on the identified argument values.

In another example, the function-level fuzzing of step 680 is again performed for the block of code preceding the block of code that was just fuzzed in order to find argument values that call the respective block of code while maintaining the respective argument values that caused the CFI event. As described above, in some examples, fuzzing agent 40 adds a hook to the previous block of code and the function-level fuzzing is performed based on snapshot taken upon arrival at the new hook of the previous block. Thus, in some examples, function-level fuzzing is repeatedly performed, going backwards through successive blocks of code, until reaching the first block of code of binary executable file 110 or until the function-level fuzzing is no longer able to reach another block. In such an example, the respective argument values and the respective block reaches is report and/or stored in step 690.

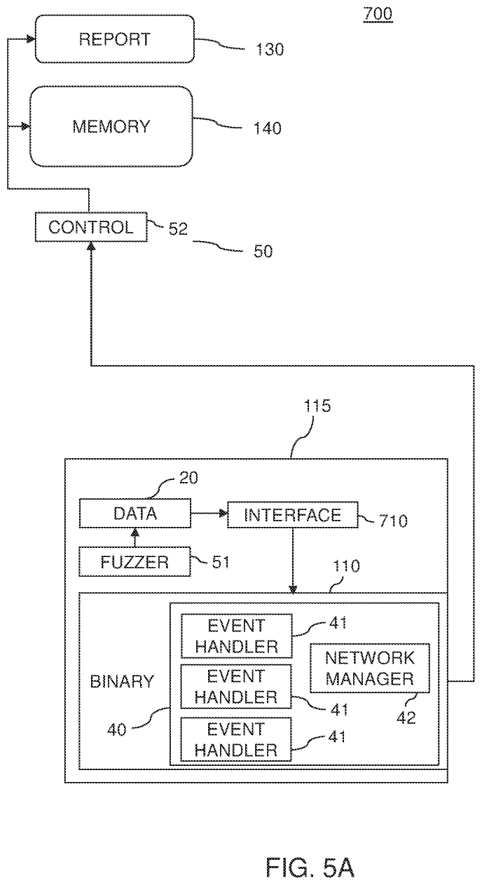

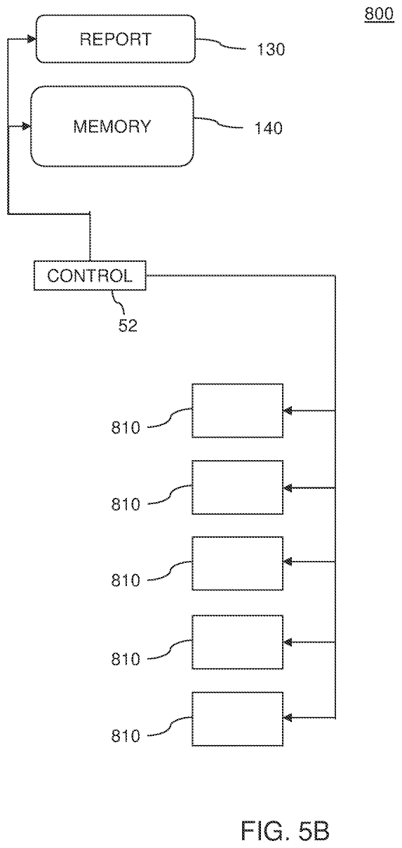

FIG. 5A illustrates a high-level block diagram of an example of a system 700 for fuzzing. System 700 is in all respects similar to system 300, with the exception that fuzzer data generator 20 and fuzzing unit 51 are inside DUT 115, while control unit 52 is external to DUT 115. In such an example, input subsystem 30 is not required since data units are provided from fuzzer data generator 20 to binary executable file 110 via a local host interface 710. Advantageously, this reduces the latency of the network which exists when data units enter through input subsystem 30.

In some examples, fuzzer data generator 20 sends data units to binary executable file 110 via a local host interface 710 implemented as a loopback network interface. In some examples, fuzzing agent 40 adds a hook at an initialization function to configure the communication between fuzzer data generator 20 and binary executable file 110. In one further example, fuzzing agent 40 adds a hook at socket.bind. As described above, in such an example, socket.bind is replaced with a branch instruction to a respective event handler 41, and socket.bind is run within the respective event handler 41. Event handler 41 alters socket.bind to change the sources that are listened to by the loopback network interface. In some examples, event handler 41 alters socket.bind to change the allowed listening sources to “0.0.0.0”, i.e. all listening sources are allowed.

In another example, a kernel module comprising Linux net-filter is used to modify the data units generated by fuzzer data generator 20. The term “kernel module”, as used herein, means an object file that contains code that can extend the kernel functionality at runtime, as known to those skilled in the art. In such an example, the generated data units are received by the loopback network interface and sent to the kernel module via a netfilter input chain. The net-filter then modifies the IP address of the data unit appropriately and returns it to the netfilter input chain (as known to those skilled in the art), the modified data unit then being sent to binary executable file 110.

In some examples, DUT 115 can be replaced with a virtual machine (VM) or a virtual container, such as a Docker container, commercially available from Docker Inc. of Palo Alto, California, USA. In some examples, as illustrated in FIG. 5B, a system 800 for fuzzing is provided. System 800 is in all respects similar to system 700, with the exception that DUT 115 is replaced with a plurality of virtual environments 810, such as a VM or virtual container.

In some examples, control unit 52 receives an instrumented binary executable file and a plurality of configuration files or messages. Particularly, each configuration file/message indicates which portions of the binary executable file to fuzz, and which parameters are used for fuzzing, as described above (e.g. number of data units, time for fuzzing. TARA information, etc.). Control unit 52 thus fuzzes each section of the binary executable file in a separate virtual environment 810. In some examples, each virtual environment 810 can be accessed through a local network interface. In another example, each virtual environment 810 is accessed through a network via a respective IP address. In some examples, where a local network interface is provided, each virtual environment 810 has a dedicated fuzzing unit, as described above in relation to fuzzing unit 51 of system 700.

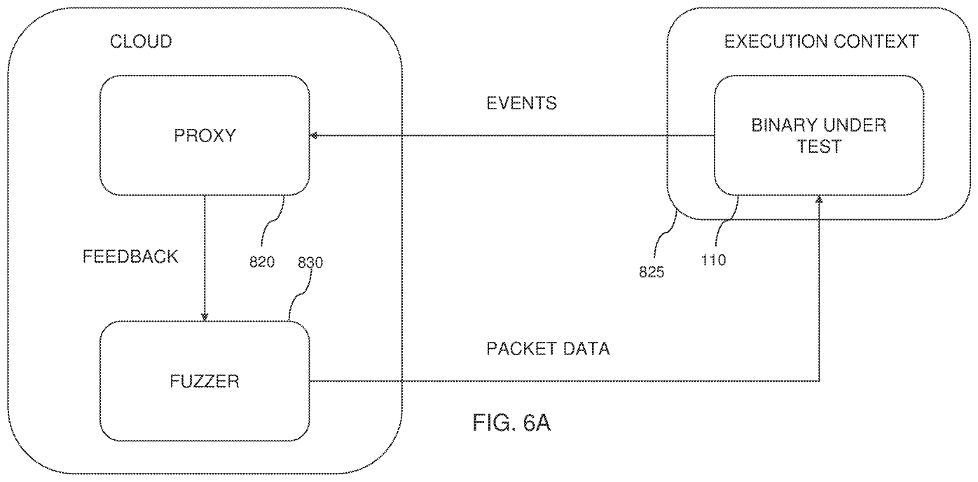

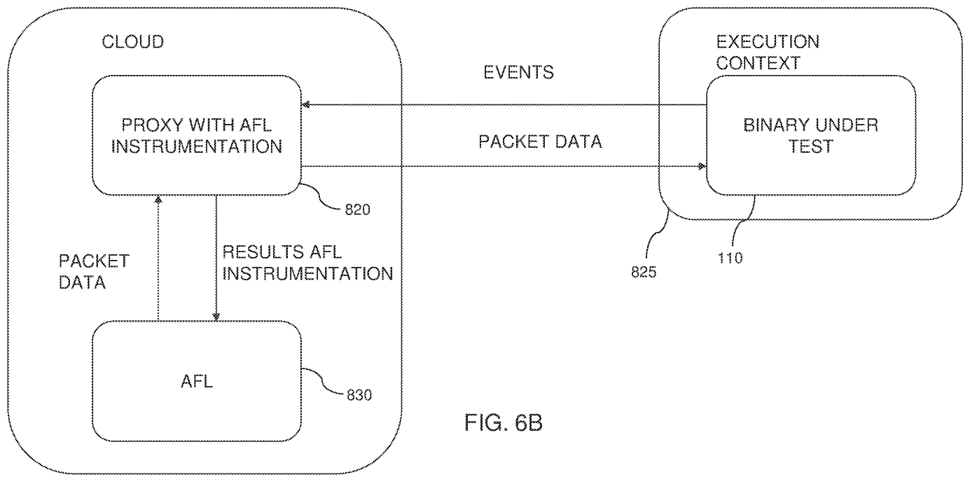

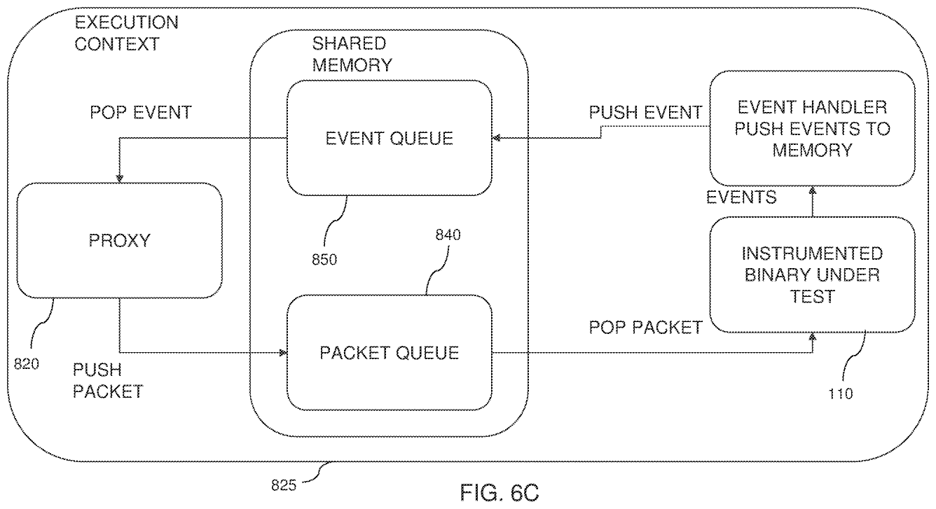

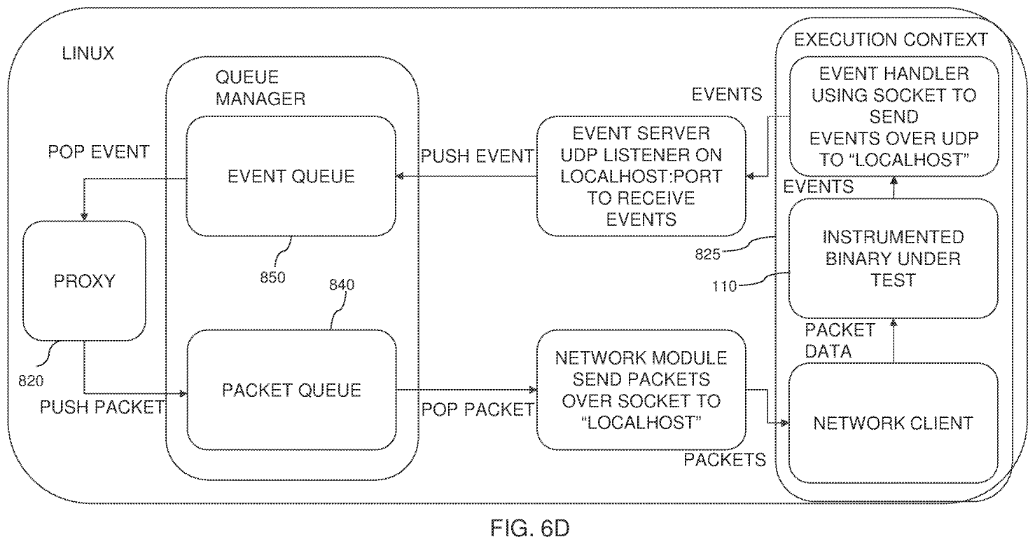

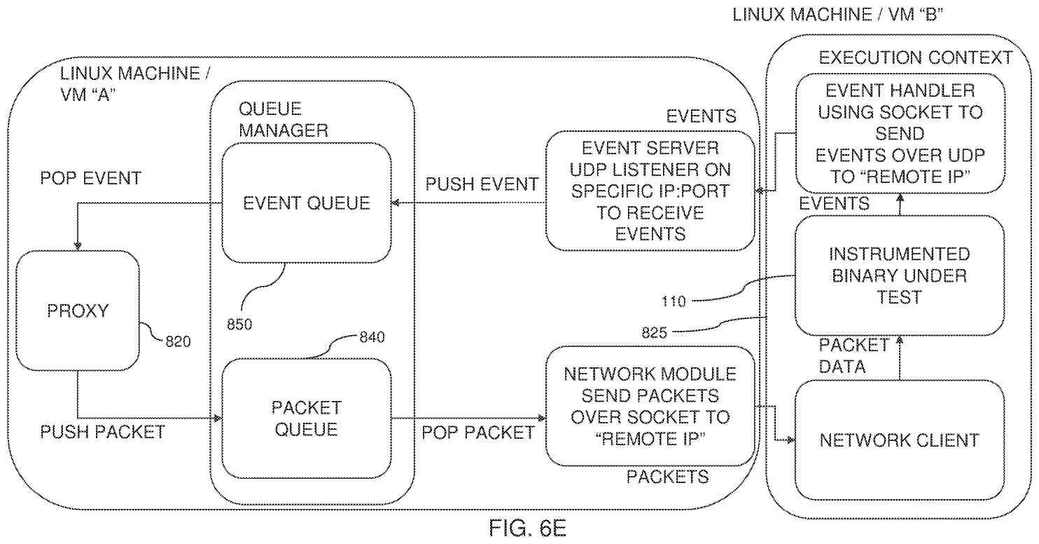

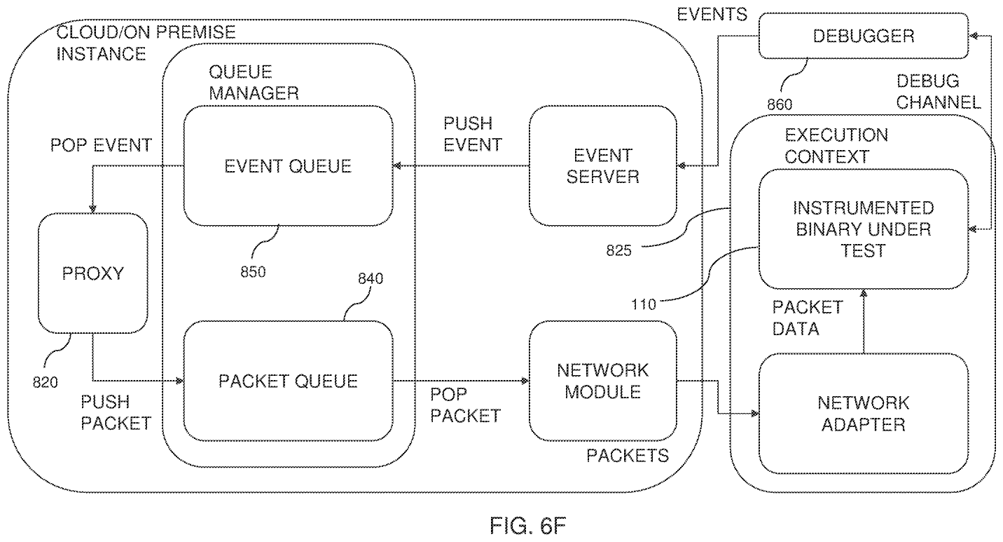

FIGS. 6A-6F illustrate various high-level block diagrams of examples of proxy-based fuzzing systems. In some examples, the steps of proxy-based fuzzing systems comprise:

a binary analysis phase; a fuzzer generation phase; and a run-time phase.

In some examples, a configuration file is created, the configuration file comprising information about the addresses of each logic block in the binary. Optionally the configuration file comprises a list of the respective addresses.

In some examples, for each block that has a condition within the block (as described above), the offset to the address of this condition and the number of arguments that are checked in this condition is added to the configuration file.

In some examples, the configuration file further comprises a list of all of the entry points to the binary. The entry points can include calls to read functions, receive functions (e.g. recvfrom), and other similar entry points.

In some examples, using the configuration file, one or more hooks are placed at respective points of interest of the binary executable file, as described above. In some examples, as described above, hooks are added at only some of the points of interest. In some examples, a list of points of interest that hooks are to be added thereat is saved in the configuration file. In some examples, the points of interest include, without limitations, entry points of the process, entry points of blocks and/or condition checks, as described above.

In some examples, in accordance to the information of the configuration file, an entry of each block is replaced with a hook, as described above. In some examples, each hook placed at the entry of each block comprises a call/branch to a respective code that sends a coverage-event message to a proxy module 820, as illustrated in FIG. 6A. The term “coverage-event message”, as used herein, means information regarding a coverage event, as described above. The coverage-event message indicates that the respective hook was reached. In some examples, the respective coverage-event message associated with each hook includes an identifier of the respective hook/block. The process of the binary executable file continues, as described above.

In some examples, in accordance with the information of the configuration file, each condition opcode is replaced with a respective hook. The term “condition opcode”, as used herein, means an opcode with a condition check, as described above. In some examples, each hook replacing the condition opcode comprises a call/branch to a respective code that sends a condition-event message to the proxy module 820. The term “condition-event message”, as used herein, means information regarding a condition event, as described above. In some examples, the condition-event message comprises the respective register values of the condition (e.g. the respective variable values and argument values of the condition). In some examples, as described above, the code also performs the condition. The process of the binary executable file continues, as described above.

In some examples, in accordance with the information of the configuration file, for one or more calls to an entry point, a hook is added. In some examples, the hook comprises a branch to a respective code that receives data from a communication channel. Particularly, as will be described below, a communication channel is opened to receive data units.

An illustrative example of a configuration file can be as follows:

TABLE 2

| | | | | Previous |
|---|---|---|---|---|
| ID | Offset | Type | Parameters | Block |
| 1 | 0x100 | Coverage | None | None |
| 2001 | 0x108 | Condition | R0, R1 | 0x100 |
| 2002 | 0x132 | Condition | R0, #223 | 0x100 |
| 2 | 0x148 | Coverage | None | 0x100 |

In some examples, CFI monitors are added are added to detect memory corruption and other CFI events. In the event that a CFI event occurs, as described above, a CFI event message is sent to the proxy module 820. The term “CFI event message”, as used herein, means information regarding a CFI event that occurred, optionally comprising details of the event.

In some examples, an event handler is embedded in the binary executable file, as described above. In some examples, the event handler sends the event messages to the communication channel.

In some examples, in accordance with the information of the configuration file, code for the proxy module 820 is generated, as will be described below. In some examples, a first portion of the code of the proxy module 820 is independent of the configuration file information and a second portion of the code of the proxy module 820 is dependent on the configuration file information. Thus, the proxy module 820 can be programmed in advance and then updated responsive to the received configuration file.

In some examples, responsive to a received user input, the fuzzer grammar and the fuzzer seed is generated.

In some examples, as described above, the binary executable file 110 runs in an execution context 825, such as a DUT or a virtual environment, such as a virtual machine or an emulator. In some examples, the binary executable file 110 receives data from the communication channel, as will be described below. The binary executable file 110 then processes the incoming data.

When the logic flow control arrives at a hook in the beginning of a block, a coverage-event message is generated (as described above) and sent to the proxy module via the communication channel. Similarly, when the logic flow control arrives at a condition, a condition-event message is generated (as described above) and sent to the proxy module via the communication channel.

The proxy module 820 comprises source code, therefore it can be compiled to support various fuzzers, including coverage-guided fuzzers, such as AFL (as illustrated in FIG. 6B), Libfuzzer and AFL++, as known to the skilled in the art. In some examples, the proxy module 820 communicates with the instrumented binary executable file 110 using the communication channel, as will be described below.

The proxy module 820 receives event messages (e.g. coverage-event messages and condition-event messages) from the instrumented binary executable file 110. In some examples, the event handler of the proxy module comprises is configured to wait for a predetermined time period (preferably measured in microseconds) after receiving events to decide that it received the last event for the sent data unit and only after this timeout does it sends the next data unit of the fuzzing process. In some examples, waiting is performed in the following cases, without limitation: when there are dependencies between events; when the server utilizes a request-response technique for sending data units; and/or where the binary executable file comprises a plurality of threads, and the transmitted data unit may trigger events from more than one thread.

As will be described below, the proxy module 820 provides inputs to a fuzzer 830 (e.g. AFL, Libfuzzer or AFL++) responsive to the received events. In some examples, the proxy module 820 comprises a plurality of branch instructions. The proxy module is described herein as comprising a plurality of functions, each function being called responsive to a respective event message, however this is not meant to be limiting in any way. In some examples, the proxy module 820 comprises a plurality of conditions (such as ‘if’ statements), each being branched to responsive to a respective event message. In some examples, passing the condition can increment a counter, or other suitable act. In some examples, the proxy module comprises a look up table that calls a function when getting a respective event message.

In some examples, the proxy module comprises an array of all the functions, such as the following:

void (*Funcs[NUMBER_OF_EVENTS])( ) =
{function_handler_100,
function_handler_148, ... };

In some examples, for each event listed in the configuration file, a respective function is generated. In some examples, hooks are placed at every block entry point and every condition check in the binary executable file, however the configuration file contains a dedicated list of a portion of the events that are to be used for fuzzing. In such examples, the event handler of the proxy module 820 will ignore the other events thereby focusing the fuzzing to flows of one or more predetermined points of interest.

In some examples, when the proxy module 820 is started, an initialization step includes reading the configuration file from the memory. In some examples, the event handler of the proxy module 820 will read the list of event IDs from the configuration file and only act upon received events whose IDs are in the list. In some examples, if the configuration file does not include a list of events, or such a list is empty, the event handler of the proxy module 820 will act upon each event. In some examples, this provides the ability to change the point of interest being fuzzed by simply creating a new configuration file.

The fuzzer 830 is designed to update and output data units in order to reach as many functions as possible, as known to those skilled in the art of coverage-guided based fuzzing. With the proxy module 820, the fuzzer 830 is trying to increase the coverage within the proxy module 820, i.e. the number of functions being reached, where each function is called responsive to a respective event within the binary executable file 110. In some examples, this allows the use of standard coverage-guided based fuzzers to indirectly fuzz a binary executable file 110 even it is unable to directly fuzz the binary executable file due to certain constraints (e.g. a lack of source code).

In some examples, for each condition event message, the respective function comprises a condition check and a call to a pair of dedicated functions. In one illustrative example, as described above in Table 2, one condition event may have an offset of 0x132, and the condition event message comprises the argument value of R0 and the hard condition value, which equals 223. In such an illustrative example, the respective function may look like this:

void function_handler_100(void){
if (R0 == 223){
success_132( );
}else{
Failure_132( );
}
Void function_ success_132 (void){ }
Void function_ Failure _132 (void){ }

In such an example, the respective success function will be called only if the original condition has been met, otherwise the failure function will be called. The fuzzer 830 is configured to continue adjusting data units until the success function is called.

By checking the original condition, the fuzzer 830 can continue fuzzing until the condition is reached. In some examples, the fuzzer comprises a dedicated algorithm that keeps updating data units in such a way that the distance between R0 and 223 is minimized. Although the above has been described in relation to a particular numerical example, this is true for all condition checks. Additionally, instead of fixed number (e.g. 223), the condition event message may include a non-fixed value, such as R1. In such an example, the fuzzing continues until the value of R0 equals the value of R1. Thus, regardless of the condition, the coverage-guided based fuzzer can be used to fuzz the binary executable file.

In one illustrative example, when a condition event message is received, the code of the proxy module may look like this:

Event_handler( ){
Int E = Receive_event_from_communication( );
If (E is condition_event){
Set RO,R1 as received from the event message
}
Funcs[E]( );
}

In such an illustrative example, the values are set as the register values associated with the condition check in the binary executable file and the respective function is then called.

In some examples, in the event of a crash, the binary executable file 110 under test won't run anymore. This can mean that the crash isn't reported to the proxy module 820. Thus, in some examples, the system further comprises a monitor that detects runtime faults of the binary executable file under test and reports the runtime faults to the proxy module 820 with a fault event message. Responsive to receiving a fault event message, in some examples the proxy module 820 calls an error function which crashes the proxy module 820, thereby the fuzzer 830 sees a crash.

In some examples, such a monitor comprises a debugger, which will also allow for post mortem analysis.

In some examples, the monitor may perform any, or a combination of, the following functions: reporting crashes, including the cause of the crash, e.g., seg fault; providing a core dump responsive to a crash (for performing post mortem analysis); and injecting trace points, for example for counting the size of allocated memory and number of free calls, to detect memory leaks.

In some examples, as illustrated in FIG. 6C, where the proxy module 820 and the binary executable file 110 are run in the same execution context 825, a shared memory can be used to forward data units to the binary executable file under test as well as reporting events back to the proxy module. Data units are referred hereinafter as packets, however this is not meant to be limiting in any way, and any type of data transmission can be used without exceeding the scope of the disclosure.

In some examples, two separate queues are used: a packet queue; and an event queue. In some examples, the packet queue buffers packets provided by the proxy module 820. In some examples, a packet injection engine pops packets from the queue and injects them into the receiving mechanism of the binary executable file 110 under test, e.g., by linking against a prepared recv call.

In some examples the event handler embedded in the binary executable file 110 gathers events (as described above) and pushes these events to the event queue. Then, the proxy module 820 can pop events as needed.

In some examples, as illustrated in FIGS. 6D-6E, where the proxy module 820 and the binary executable file 110 under test don't run in the same execution context, a communication socket is used to forward packet data to the binary executable file 110 under test as well as reporting events back to the proxy module 820. In some examples, as illustrated in FIG. 6D, the proxy module 820 runs on the same machine as the binary executable file 110. Alternatively, as illustrated in FIG. 6E, the proxy module 820 runs in one machine and the target binary executable file 110 runs on a separate machine.

In some examples, two separate queues are used: a packet queue 840; and an event queue 850. In some examples, the packet queue 840 buffers packets provided by the proxy module 820. In some examples, the packet injection engine pops packets from the queue 840 and sends them using a socket to the binary executable file 110 under test. In a case where the binary executable file 110 doesn't use sockets for communication, in some examples a socket listener (for listening to network communication) is added to the binary executable file 110 under test. In some examples, the socket listener (also called a “network client”) receives the packet and injects it into the entry point of the binary executable file. For example, it can feed the specific code that was added to the entry point with data.

In some examples, the event handler embedded in the binary executable file gathers events (as described above) and sends them using a dedicated UDP message to the proxy module 820. In some examples, where the proxy module 820 and the binary executable file 110 run on the same machine, the UDP message can be a simple UDP message to “localhost”. In some examples, where the proxy module 820 and the binary executable file 110 run on separate machines, the proxy module 820 sends the message to a remote IP address. In some examples, the proxy module 820 implements a UDP listener to receive UDP packets.

In some examples, as illustrated in FIG. 6F, when fuzzing firmware or Portable Operating System Interface (POSIX) binary executable files 110 on their native target hardware, events are read by a debugger 860. In some examples, the packets are forwarded to the network adapter of the target hardware.

In some examples, two separate communication channels are used: a communication channel for packets; and a communication channel for events. In some examples, the packet queue buffers packets provided by the proxy module 820, as described above. In some examples, the network module pops packets from the queue 840 and forwards them to the network adapter of the target hardware. In some examples, forwarding the popped packets is done while upholding rate limitations of the network adapter.

In some examples, the instrumented binary executable file logs events into a global buffer. In some examples, the global buffer is polled cyclically with a debugger 860. In some examples, the software controlling the debugger 860 forwards the events to the event server located in the execution context of the proxy module. In some examples, the events are then sent to the queue manager, as described above.

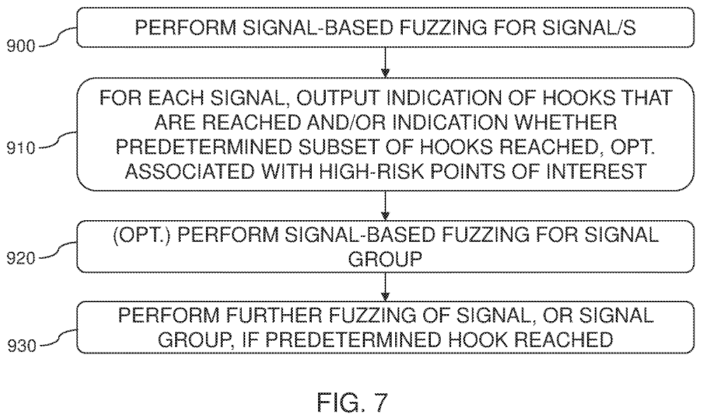

FIG. 7 illustrates a high-level flow chart of a method of signal-based fuzzing. The term “signal-based fuzzing”, as used herein, means fuzzing a target based on changes made to a signal. Particularly, each signal has its own predetermined location within a respective payload. Thus, fuzzing is performed by making changes (e.g., by mutation) to the bits in the respective location of the payload, while the respective location represents the location of the respective signal which is typically sent to the binary executable file. It is contemplated that different signals can be associated with different origins and/or destinations, thus in some examples each signal within a data unit (or a network packet) is defined based on the location within the data unit, and one or more identifiers of the data unit. As described above, fuzzing comprises continuously adjusting data units and then inputting the data units into the target.

In some examples, in stage 900, signal-based fuzzing is performed for one or more predetermined signals. In some examples, the signal-based fuzzing is performed as described above in relation to any of systems 10, 215, 300, 700 or 800. In some examples, the signal-based fuzzing is performed using a different fuzzer, such as an AFL fuzzer.

In some examples, in stage 910, when a hook is reached, the respective hook outputs information associated with the respective point of interest, as described above. In some examples, fuzzer evaluation functionality 50 stores and/or outputs information regarding the signal and the hook/s reached. In some examples, for each signal being fuzzed, fuzzer evaluation functionality 50 outputs a list of the hooks and/or points of interest reached.

In some examples, for each signal being fuzzed, fuzzer evaluation functionality 50 determines whether one or more of a subset of hooks was reached by the respective signal, and in some examples further outputs an indication whether the one or more hooks were reached. In some examples, the subset of hooks are associated with higher-risk points of interest. Thus, it is determined whether the respective signal reaches any such high-risk points of interest.

In one illustrative example, an output of fuzzer evaluation functionality 50 can include the following fields:

TABLE 3

| Binary ID | Signal ID | List of Hooks Reached |
|---|---|---|
| B1 | S1 | H1, H3, H7 . . . |
| B1 | S2 | H2, H3, H9 . . . |
| B1 | S3 | H4, H5, H11 . . . |

As shown, in such an example, the list of hooks reached by each signal, in each binary executable file, can be provided.

In some examples, the output of fuzzer evaluation functionality 50 (such the output described in Table 3) is output to an external system, an external network and/or a user terminal.

In some examples, in stage 920, the one or more signals of stage 900 comprises a plurality of signals, i.e., a group of signals, each of the signals being in a different location of the same data unit/payload. In some examples, the signal-based fuzzing is performed for the group of signals together. In some examples, this comprises changing the bits of all of the signals as a single block of data. In some examples, this comprises changing the bits of one or more of the plurality of signals separately, in accordance with predetermined rules. It is noted that certain values of a certain signal may reach a particular point of interest only in the event that a second signal has one or more particular value. Thus, fuzzing the signals together (either as a single block of data, or in a predetermined order) can aid in reaching the respective point of interest. In some examples, fuzzer evaluation functionality 50 outputs information regarding the hooks (and/or points of interest) reached by the group of signals together.

In some examples, in stage 930, based at least in part on the determination that one or more particular points of interest are reached by a respective signal (such as high-risk points of interest), fuzzer evaluation functionality 50 determines that the respective signal should be fuzzed further. In some examples, points of interest are defined as high-risk by fuzzer evaluation functionality 50 and/or an external input. In some examples, fuzzer evaluation functionality 50 defines points of interest as high-risk based at least in part on externally received data. In some examples, fuzzer evaluation functionality 50 received TARA information, and defining points of interest as high-risk is based at least in part of the received TARA information. In some examples, each point of interest is assigned a respective risk value (by an external input and/or by fuzzer evaluation functionality 50), and a threshold is defined such that each point of interest having assigned thereto a risk value greater than the threshold is defined as a high-risk point of interest.

High-risk points of interest can be any points of interest defined as high-risk, including, but not limited to: access points; access points to software/hardware with a high-risk value, optionally determined by a risk assessment, such as TARA; and/or a point of interest with a known vulnerability, for example having a known Common Vulnerabilities and Exposures (CVE) identifier.

In some examples, as long as the particular point of interest has not been reached, only a predetermined maximum number of changes are made to the signal for fuzzing. However, once the particular point of interest has been reached, in some examples a larger number of changes can be made to the signal for fuzzing. Thus, intelligent fuzzing is provided where signals are more heavily fuzzed if they reach predetermined points of interest, and less heavily fuzzed if they don't reach the predetermined points of interest.

In some examples, this further fuzzing comprising fuzzing the signal to arrive at additional points of interest, the additional points of interest optionally being points of interest accessed through the first point of interest. For example, the particular point of interest can be an access point to a respective system, such as an access point to a modem. Once the access point is reached, further fuzzing is performed on the respective signal to reach additional points of interest within the accessed system. In some examples, the further fuzzing comprises fuzzing the signal in order to generate: an error or fault in the system; and/or a heavy CPU load. In some examples, the further fuzzing comprises fuzzing the signal for at least a predetermined time period.

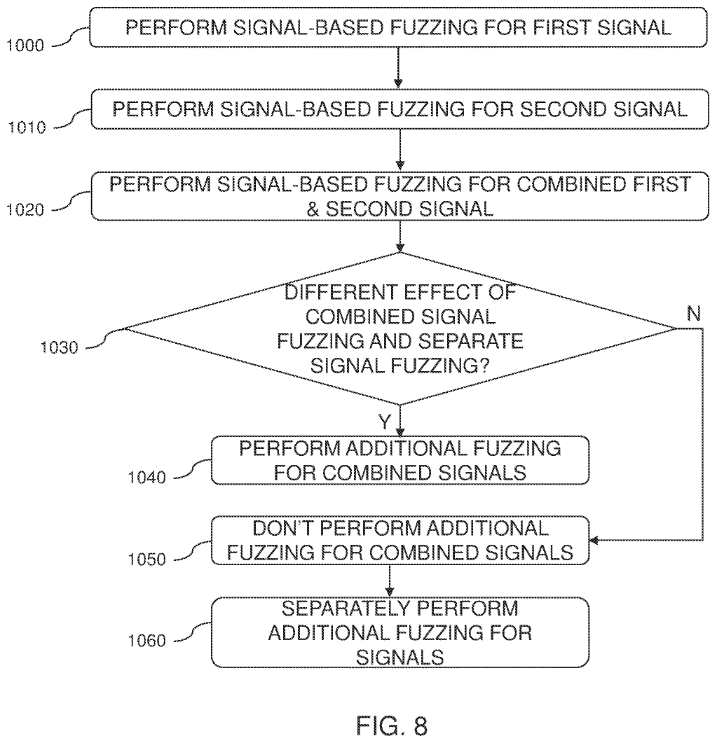

FIG. 8 illustrates a high-level flow chart of a method of identifying statistical independence of a plurality of signals. The below will be described in relation to examples regarding analyzing the statistical independence of two signals, however this is not meant to be limiting in any way, and the statistical independence of any number of signals can be determined with any number of signals, without exceeding the scope of the disclosure.

In some examples, in stage 1000, signal-based fuzzing is performed for a first signal, as described above. In some examples, the signal-based fuzzing is performed as described above in relation to any of systems 10, 215, 300, 700 or 800. In some examples, the signal-based fuzzing is performed using a different fuzzer, such as an AFL fuzzer. In some examples, while changes are made to the first signal no changes are made to a second signal.

In some examples, fuzzer evaluation functionality 50 determines which hooks were reached by the data units, as described above. In some examples, fuzzer evaluation functionality 50 determines other effects of the first signal, such as a high-load on the CPU.

In some examples, in stage 1010, signal-based fuzzing is performed for the second signal of stage 1000, as described above. In some examples, while changes are made to the second signal no changes are made to the first signal. In some examples, as described in relation to stage 1000, fuzzer evaluation functionality 50 determines which hooks were reached by the data units and/or determines other effects of the second signal.

In some examples, in stage 1020, signal-based fuzzing is performed for the first and second signals of stage 1000 and 1010 together. Particularly, the fuzzing comprises making changes to the bits in the locations of both signals within the data unit. In some examples, as described in relation to stage 1000, fuzzer evaluation functionality 50 determines which hooks were reached by the data units and/or determines other effects of the first and second signal.

In some examples, in stage 1030, fuzzer evaluation functionality 50 determines whether there is a difference in the effect of: the fuzzing of the first signal of stage 1000 and the fuzzing of the second signal of stage 1010; the combined fuzzing of the first and second signals of stage 1020. For example, if the data units of stage 1000 reach a first set of hooks, the data units of stage 1010 reach a second set of hooks (which may at least partially overlap the first set of hooks), and the data units of stage 1020 reach a third set of hooks, fuzzer evaluation functionality 50 compares the third set of hooks to the first and second set of hooks. If the third set of hooks contain one or more hooks that are not present in at least one of the first set of hooks (reached by fuzzing the first signal) and the second set of hooks (reached by fuzzing the second signal), it is determined that there is a statistical dependence between the two signals in the target binary executable file. If the third set of hooks does not contain any hooks that are not present in at least one of the first set of hooks and the second set of hooks, it is determined that the first signal and the second signal are statistically independent in the target binary executable file.

In some examples, if the data units of stage 1020 cause an effect (e.g., a high CPU load) that did not appear in stages 1000 and 1010, it is determined that the first signal and the second signal are statistically independent in the target binary executable file.

In some examples, fuzzer evaluation functionality 50 outputs an indication of the statistical dependence, or independence, of the first signal of stage 1000 and the second signal of stage 1010. In some examples, the indication is output to a user terminal, such as a user display. In some examples, the indication is stored in a memory. In some examples, a list of signals is stored, and each signal has associated therewith an indication of its statistical dependence, or independence, with other signals.

In some examples, in stage 1040, fuzzer evaluation functionality 50 determines whether or not to fuzz the first signal and the second signal together. In some examples, if in stage 1030 it was determined that the first and second signal are statistically independent, fuzzer evaluation functionality 50 performs signal-based fuzzing separately for the first and second signal. In some examples, in stage 1050, fuzzing of the first and second signals together is not performed. In some examples, signal-based fuzzing for each of the first and second signals is performed before stage 1040, and the determination of stage 1040 is performed only for determining whether or not to provide further fuzzing for a combination of the two signals.

In some examples, in stage 1060, separate fuzzing for one, or both, of the first and second signals is further performed. For example, additional cycles of fuzzing can be performed for the first signal and/or the second signal instead of fuzzing for the combination of the first and second signals.

Thus, in some examples, a limited number of data units are used for an initial fuzzing step of the combined signals. If it is determined that the two signals are not statistically independent, then further fuzzing is performed with additional data units, as described above.

### SOME EXAMPLES OF THE DISCLOSED TECHNOLOGY

Some examples of above-described implementations are enumerated below. It should be noted that one feature of an example in isolation or more than one feature of the example taken in combination and, optionally, in combination with one or more features of one or more examples below are examples also falling within the disclosure of this application.

Example 1. A system for fuzzing, the system comprising: a fuzzer data generator configured to continuously generate units of data; a first input subsystem configured to input each of the generated units of data into a tested device, an input of the first input subsystem in communication with an output of the fuzzer data generator and an output of the first input subsystem in communication with the tested device; a first fuzzing agent configured to add each of one or more hooks to a respective one of one or more predetermined points of interest in a binary executable file running on the tested device, wherein responsive to the input units of data, each hook outputs information associated with the respective point of interest, the output information comprising data stored in a respective address of a memory associated with the respective point of interest; and a fuzzer evaluation functionality configured to receive the information from each of the one or more hooks, wherein the fuzzer data generator is in communication with the fuzzer evaluation functionality and the generation of the units of data by the fuzzer data generator is responsive to an output of the fuzzer evaluation functionality.

Example 2. The system of any example herein, particularly example 1, wherein the fuzzing agent is embedded in the binary executable file.

Example 3. The system of any example herein, particularly any one of examples 1-2, wherein the first fuzzing agent is configured to add the one or more hooks to the binary executable file without re-compiling the binary executable file.

Example 4. The system of any example herein, particularly any one of examples 1-3, wherein, for each of the one or more respective points of interest, responsive to the respective output information, the fuzzer evaluation functionality or the first fuzzing agent is configured to determine which of the input units of data reached the respective hook, and wherein the generation of the units of data by the fuzzer data generator is responsive to an outcome of the determination.

Example 5. The system of any example herein, particularly example 4, further comprising a time stamp generator, wherein, for each of the input units of data, the time stamp generator is configured to set a time stamp associated with the input of the respective unit of data into the tested device, wherein, for each respective point of interest, the time stamp generator is configured to set a respective time stamp each time that a hook was reached, and wherein the determination which of the input units of data reached the respective hook is responsive to a difference between the time stamp of the respective hook and the time stamps of the input data units.

Example 6. The system of any example herein, particularly example 4 or 5, wherein responsive to the information received at the fuzzer evaluation functionality, the fuzzer evaluation functionality is configured to output to the first fuzzing agent an indication of a respective one of the one or more points of interest, and wherein, responsive to the output indication of the respective point of interest, the first fuzzing agent is configured to add a respective hook to an additional location in the binary executable file associated with the respective point of interest.

Example 7. The system of any example herein, particularly example 6, wherein the fuzzer evaluation functionality is configured to output to the first fuzzing agent the indication of the respective point of interest responsive to not receiving information associated with the respective point of interest over at least a predetermined time period.

Example 8. The system of any example herein, particularly example 7 or 8, wherein the additional location is located earlier in a flow of the binary executable file than the respective point of interest.

Example 9. The system of any example herein, particularly any one examples 1-8, wherein responsive to a respective one of the one or more hooks not being activated within a predetermined first time period, the fuzzer evaluation functionality is configured to:
identify a comparison opcode located prior to the respective hook, the comparison opcode having associated therewith a comparison value and a variable value; repeatedly receive from the first fuzzing agent the comparison value and the variable value over multiple instances of the first predetermined time period; responsive to the variable value and the comparison value, control the fuzzer data generator to repeatedly adjust the generated units of data; and responsive to the variable value being equal to the comparison value, determine the necessary adjustment of the generated units of data to cause the variable value to be equal to the comparison value, wherein the fuzzer data generator adjusts the generated units of data in accordance with the necessary adjustment.

Example 10. The system of any example herein, particularly example 9, wherein the fuzzer evaluation functionality is configured to: repeatedly control, or indicate to, the fuzzer data generator to insert a predetermined value within a respective location of a respective data unit, the respective location for each repetition being different; and analyze a memory stack associated with the binary executable file to determine which of the respective locations affect the memory stack, the repeated adjustments of the generated units of data until the variable value is equal to the comparison value being responsive to an outcome of the determination of the respective location.

Example 11. The system of any example herein, particularly any one of examples 1-10, wherein the information associated with the respective point of interest comprises an indication that the respective point of interest was reached, and wherein the fuzzer evaluation functionality is configured to perform a statistical evaluation of a number of times that each of the one or more predetermined points of interest was initiated.

Example 12. The system of any example herein, particularly any one of examples 1-11, wherein the fuzzer evaluation functionality is configured to compare the data stored in the respective address of memory to corresponding data copied from the respective address at a previous time point, and wherein, responsive to an outcome of the comparison indicating that the data is different than the data from the previous time point, the fuzzer evaluation functionality outputs an indication of the presence of a difference.

Example 13. The system of any example herein, particularly any one of examples 1-12, further comprising: a second fuzzing agent associated with a copy of the binary executable file running on an emulator or virtual machine; and a second input subsystem configured to input each of the generated units of data into the emulator or virtual machine, an input of the second input subsystem in communication with the output of the fuzzer data generator and an output of the second input subsystem in communication with the emulator or virtual machine, wherein a respective one of the one or more predetermined points of interest is an entry point of a function, wherein responsive to the received information from the hook associated with the entry point of the function, the fuzzer evaluation functionality is configured to generate a snapshot of the memory, the snapshot comprising instructions and values stored in each address from the beginning of a process of the binary executable file until the entry point of the function, wherein, based at least in part on the generated snapshot, the second fuzzing agent is configured to set respective values of the emulator or virtual machine such that units of data input to the emulator or virtual machine will arrive at the entry point of the function within the copy of the binary executable file.

Example 14. A method for fuzzing, the method comprising: continuously generating units of data; inputting each of the generated units of data into a tested device; and adding each of one or more hooks to a respective one of one or more predetermined points of interest in a binary executable file running on the tested device, wherein responsive to the input units of data, each hook outputs information associated with the respective point of interest, the output information comprising data stored in a respective address of a memory associated with the respective point of interest, wherein the generation of the units of data is responsive to the output information associated with the respective points of interest.

Example 15. The method of any example herein, particularly example 14, wherein the adding the one or more hooks to the binary executable file is performed without re-compiling the binary executable file.

Example 16. The method of any example herein, particularly example 14 or 15, wherein, for each of the one or more respective points of interest, responsive to the respective output information, determining which of the input units of data reached the respective hook, and wherein the generation of the units of data is responsive to an outcome of the determination.

Example 17. The method of any example herein, particularly example 16, further comprising: for each of the input units of data, setting a time stamp associated with the input of the respective unit of data into the tested device; and for each respective point of interest, setting a respective time stamp each time that a hook was reached, wherein the determination which of the input units of data reached the respective hook is responsive to a difference between the time stamp of the respective hook and the time stamps of the input data units.

Example 18. The method of any example herein, particularly example 16 or 17, further comprising: responsive to the output information, outputting an indication of a respective one of the one or more points of interest; and responsive to the output indication of the respective point of interest, adding a respective hook to an additional location in the binary executable file associated with the respective point of interest.

Example 19. The method of any example herein, particularly example 18, further comprising outputting the indication of the respective point of interest responsive to not receiving information associated with the respective point of interest over at least a predetermined time period.

Example 20. The method of any example herein, particularly example 18 or 19, wherein the additional location is located earlier in a flow of the binary executable file than the respective point of interest.

Example 21. The method of any example herein, particularly any one examples 16-20, further comprising, responsive to a respective one of the one or more hooks not being activated within a predetermined first number of the predetermined time period: identifying a comparison opcode located prior to the respective hook, the comparison opcode having associated therewith a comparison value and a variable value; repeatedly receiving the comparison value and the variable value over multiple instances of the predetermined time intervals; responsive to the variable value and the comparison value, repeatedly adjusting the generated units of data; and responsive to the variable value being equal to the comparison value, determining the necessary adjustment of the generated units of data to cause the variable value to be equal to the comparison value, wherein the adjustment of the generated units of data is in accordance with the necessary adjustment.

Example 22. The method of any example herein, particularly example 20 or 21, further comprising: repeatedly inserting a predetermined value within a respective location of a respective data unit, the respective location for each repetition being different; and analyzing a memory stack associated with the binary executable file to determine which of the respective locations affect the memory stack, the repeated adjustments of the generated units of data until the variable value is equal to the comparison value being responsive to an outcome of the determination of the respective location.

Example 23. The method of any example herein, particularly any one of examples 14-22, wherein the information associated with the respective point of interest comprises an indication that the respective point of interest was reached, and wherein the method further comprises performing a statistical evaluation of a number of times that each of the one or more predetermined points of interest was initiated.

Example 24. The method of any example herein, particularly any one of examples 14-23, further comprising: comparing the data stored in the respective address of memory to corresponding data copied from the respective address at a previous time point; and responsive to an outcome of the comparison indicating that the copied data is different than the copied data from the previous time point, outputting an indication of the presence of a difference.

Example 25. The method of any example herein, particularly any one of examples 14-24, wherein, for each of a plurality of signals, the units of data are continuously generated to perform signal-based fuzzing of the tested device.

Example 26. The method of any example herein, particularly example 25, further comprising, for each of the plurality of signals: determining whether a respective one of the one or more predetermined points of interest has been reached; and based at least in part on the determination that the respective point of interest has been reached, perform further fuzzing of the respective signal.

Example 27. The method of any example herein, particularly example 25 or 26, further comprising, for each of the plurality of signals, outputting an indication of the one or more points of interest reached by the respective units of data.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable subcombination.

Unless otherwise defined, all technical and scientific terms used herein have the same meanings as are commonly understood by one of ordinary skill in the art to which this invention belongs. Although methods similar or equivalent to those described herein can be used in the practice or testing of the present invention, suitable methods are described herein.

All publications, patent applications, patents, and other references mentioned herein are incorporated by reference in their entirety. In case of conflict, the patent specification, including definitions, will prevail. In addition, the materials, methods, and examples are illustrative only and not intended to be limiting.

It will be appreciated by persons skilled in the art that the present invention is not limited to what has been particularly shown and described hereinabove. Rather the scope of the present invention is defined by the appended claims and includes both combinations and subcombinations of the various features described hereinabove as well as variations and modifications thereof which would occur to persons skilled in the art upon reading the foregoing description.

1. A system for fuzzing, the system comprising:
a fuzzer data generator configured to continuously generate units of data;
a first input subsystem configured to input each of the generated units of data into a tested device, an input of the first input subsystem in communication with an output of the fuzzer data generator and an output of the first input subsystem in communication with the tested device;
a first fuzzing agent configured to add each of one or more hooks to a respective one of one or more predetermined points of interest in a binary executable file running on the tested device, wherein responsive to the input units of data, each hook outputs information associated with the respective point of interest, the output information comprising data stored in a respective address of a memory associated with the respective point of interest; and
a fuzzer evaluation functionality configured to receive the information from each of the one or more hooks,
wherein the fuzzer data generator is in communication with the fuzzer evaluation functionality and the generation of the units of data by the fuzzer data generator is responsive to an output of the fuzzer evaluation functionality.

2. The system of claim 1, wherein the first fuzzing agent is embedded in the binary executable file.

3. The system of claim 1, wherein the first fuzzing agent is configured to add the one or more hooks to the binary executable file without re-compiling the binary executable file.

4. The system of claim 1, wherein, for each of the one or more respective points of interest, responsive to the respective output information, the fuzzer evaluation functionality or the first fuzzing agent is configured to determine which of the input units of data reached the respective hook, and
wherein the generation of the units of data by the fuzzer data generator is responsive to an outcome of the determination.

5. The system of claim 4, further comprising a time stamp generator,
wherein, for each of the input units of data, the time stamp generator is configured to set a time stamp associated with the input of the respective unit of data into the tested device,
wherein, for each respective point of interest, the time stamp generator is configured to set a respective time stamp each time that a hook was reached, and
wherein the determination which of the input units of data reached the respective hook is responsive to a difference between the time stamp of the respective hook and the time stamps of the input data units.

6. The system of claim 1, wherein responsive to the information received at the fuzzer evaluation functionality, the fuzzer evaluation functionality is configured to output to the first fuzzing agent an indication of a respective one of the one or more points of interest, and
wherein, responsive to the output indication of the respective point of interest, the first fuzzing agent is configured to add a respective hook to an additional location in the binary executable file associated with the respective point of interest.

7-13. (canceled)

14. A method for fuzzing, the method comprising:
continuously generating units of data;
inputting each of the generated units of data into a tested device; and
adding each of one or more hooks to a respective one of one or more predetermined points of interest in a binary executable file running on the tested device, wherein responsive to the input units of data, each hook outputs information associated with the respective point of interest, the output information comprising data stored in a respective address of a memory associated with the respective point of interest,
wherein the generation of the units of data is responsive to the output information associated with the respective points of interest.

15. The method of claim 14, wherein the adding the one or more hooks to the binary executable file is performed without re-compiling the binary executable file.

16. The method of claim 14, wherein, for each of the one or more respective points of interest, responsive to the respective output information, determining which of the input units of data reached the respective hook, and
wherein the generation of the units of data is responsive to an outcome of the determination.

17. The method of claim 16, further comprising:
for each of the input units of data, setting a time stamp associated with the input of the respective unit of data into the tested device; and
for each respective point of interest, setting a respective time stamp each time that a hook was reached,
wherein the determination which of the input units of data reached the respective hook is responsive to a difference between the time stamp of the respective hook and the time stamps of the input data units.

18. The method of claim 16, further comprising:
responsive to the output information, outputting an indication of a respective one of the one or more points of interest; and
responsive to the output indication of the respective point of interest, adding a respective hook to an additional location in the binary executable file associated with the respective point of interest.

19. The method of claim 18, further comprising outputting the indication of the respective point of interest responsive to not receiving information associated with the respective point of interest over at least a predetermined time period.

20. The method of claim 18, wherein the additional location is located earlier in a flow of the binary executable file than the respective point of interest.

21. The method of claim 16, further comprising, responsive to a respective one of the one or more hooks not being activated within a predetermined first number of the predetermined time period:
identifying a comparison opcode located prior to the respective hook, the comparison opcode having associated therewith a comparison value and a variable value;
repeatedly receiving the comparison value and the variable value over multiple instances of the predetermined time intervals;
responsive to the variable value and the comparison value, repeatedly adjusting the generated units of data; and
responsive to the variable value being equal to the comparison value, determining the necessary adjustment of the generated units of data to cause the variable value to be equal to the comparison value,
wherein the adjustment of the generated units of data is in accordance with the necessary adjustment.

22. The method of claim 20, further comprising:
repeatedly inserting a predetermined value within a respective location of a respective data unit, the respective location for each repetition being different; and
analyzing a memory stack associated with the binary executable file to determine which of the respective locations affect the memory stack, the repeated adjustments of the generated units of data until the variable value is equal to the comparison value being responsive to an outcome of the determination of the respective location.

23. The method of claim 14, wherein the information associated with the respective point of interest comprises an indication that the respective point of interest was reached, and
wherein the method further comprises performing a statistical evaluation of a number of times that each of the one or more predetermined points of interest was initiated.

24. The method of claim 14, further comprising:
comparing the data stored in the respective address of memory to corresponding data copied from the respective address at a previous time point; and
responsive to an outcome of the comparison indicating that the stored data is different than the copied data from the previous time point, outputting an indication of the presence of a difference.

25. The method of claim 14, wherein, for each of a plurality of signals, the units of data are continuously generated to perform signal-based fuzzing of the tested device.

26. The method of claim 25, further comprising, for each of the plurality of signals:
determining whether a respective one of the one or more predetermined points of interest has been reached; and
based at least in part on the determination that the respective point of interest has been reached, perform further fuzzing of the respective signal.

27. The method of claim 25, further comprising, for each of the plurality of signals, outputting an indication of the one or more points of interest reached by the respective units of data.
